(19) United States
(12) Patent Application Publication
(10) Pub. No.: US 2008/0004185 A1
(43) Pub. Date: Jan. 3, 2008

(54) Three dimensional array

(75) Inventor: Marc R. Labgold, Reston, VA (US)

Correspondence Address: PATTON BOGGS LLP, 8484 WESTPARK DRIVE, SUITE 900, MCLEAN, VA, 22102, US

(73) Assignee: Antara BioSciences Inc., Mountain View, CA (US)

(21) Appl. No.: 11/808,586

(22) Filed: Jun. 12, 2007

Related U.S. Application Data
(60) Provisional application No. 60/812,825, filed on Jun. 12, 2006.
(60) Provisional application No. 60/815,386, filed on Jun. 21, 2006.

(51) Int. Cl. C40B 30/04; C40B 40/06

(52) U.S. Cl. 506/9; 506/16

(57) ABSTRACT

The present invention provides apparatus and methods of use thereof for rapidly and specifically detecting target agents.

### FIELD OF THE INVENTION

This invention relates to a three dimensional bioarray and methods of use thereof for detecting a target agent.

### BACKGROUND OF THE INVENTION

In the following discussion certain articles and methods will be described for background and introductory purposes. Nothing contained herein is to be construed as an “admission” of prior art. Applicant expressly reserves the right to demonstrate, where appropriate, that the articles and methods referenced herein do not constitute prior art under the applicable statutory provisions.

Enzyme-linked immunosorbent assay (ELISA) is a widely used method for measuring the concentration of a particular molecule (e.g., a hormone or drug) in a fluid such as serum or urine. It is also known as enzyme immunoassay or EIA. The molecule or target agent is detected by antibodies that have been made against it; that is, for which it is the antigen. Monoclonal antibodies are often used. Due to the diversity found in the immune system and the production of monoclonal antibodies from immortalized cells of the immune system, first described by Kohler and Milstein in 1975, antibodies can be raised against a huge number of different antigens by standard immunological techniques. Potentially any target agent can be recognized by a specific antibody that will not react with any other target agent.

An ELISA typically involves coating a vessel, such as a microtiter plate with an antibody specific for a particular antigen to be detected, e.g., a molecule derived from a virus or bacteria, adding the sample suspected of containing the particular antigen, allowing the antibody to bind the antigen and then adding at least one other antibody specific to another region of the same antigen to be detected. This use of two antibodies can be referred to as a “sandwich” ELISA. Sometimes, the second antibody or even a third antibody is used that is labeled with a chromogenic or fluorogenic reporter molecule to aid in detection. The procedure may also involve the need for a chemical substrate to produce a signal. The need for multiple antibodies, which do not cross-react with other antigens, and the incubation steps involved mean that it is difficult to detect more than a single antigen in a sample in a short time period.

Another method of detecting the presence of particular target agents in a sample involves detecting the presence of nucleic acids. Several methods of detecting nucleic acids are available including PCR and hybridization techniques. PCR is well known in the art and is described in U.S. Pat. Nos. 4,683,195 and 4,683,202 to Mullis and Mullis et al., respectively. PCR is used for the amplification and detection of low levels of specific nucleic acid sequences. PCR can be used to directly increase the concentration of the target nucleic acid sequence to a more readily detectable level. A variant of PCR is the ligase chain reaction, or LCR, which uses polynucleotides that are ligated together during each cycle. PCR can suffer from non-specific amplification of non-target sequences. Other variants exist, but none have been as widely accepted as PCR.

Hybridization techniques involve detecting the hybridization of two or more nucleic acid molecules. Such detection can be achieved in a variety of ways, including labeling the nucleic acid molecules and observing the signal generated from such a label. Traditional methods of hybridization, including Northern and Southern blotting, were developed with the use of radioactive labels which are not amenable to automation. Radioactive labels have been largely replaced by fluorescent labels in most hybridization techniques. Representative forms of other hybridization techniques include the cycling probe reaction, branched DNA, Invader™ Assay, and Hybrid Capture. However, while overcoming the problem of non-specific nucleic acid amplification associated with PCR, these techniques lack the sensitivity required for many applications, especially infectious disease diagnostics. Also, due to the use of linear amplification, many hybridization techniques can take substantial periods of time to accumulate a detectable signal.

Hybridization techniques may also be used to identify a specific sequence of nucleic acid present in a sample by using microarrays (or “bioarrays”) of known nucleic acid sequences to probe a sample. Such techniques are described in U.S. Pat. No. 6,054,270. Bioarray technologies generally involve attaching short lengths of single stranded nucleic acid to a surface, each unique short chain attached in a specific known location and then adding the sample nucleic acid and allowing sequences present in the sample to hybridize to the immobilized strands. Detection of this hybridization is then carried out by labeling, typically end labeling, of the fragments of the sample to be detected prior to the hybridization. When a sample fragment hybridizes to a specific strand on the array, a signal can be detected from the label, because the position of the hybridization reaction can be detected, and the sequence of the attached strand at that location is known, the sequence of the complementary strand from the sample that has hybridized can be deduced.

Usually the detection of hybridization is by measuring a fluorescent signal; however, methods of detection using an electrochemical detection method have been disclosed. Electrochemical detection methods, and devices used in electrochemical detection methods, are discussed in U.S. Pat. Nos. 5,776,672, 5,972,692, 6,489,160, 6,667,155, 6,670131, 6,783,935, and 6,818,109, herein incorporated by reference. These electrochemical detection techniques can provide a result in a reduced time period compared to the fluorescent methods of hybridization detection. As discussed above; however, whether fluorescent or electrochemical, hybridization detection methods can be subject to false positives due to non-specific hybridization. Additionally, nucleic acid detection techniques requiring steps of nucleic acid extraction, isolation and purification may lengthen the time taken to achieve a result and also decrease the detection level of the test through the loss of nucleic acid molecules in the many washing steps involved in these isolation steps.

Nucleic acid detection techniques, while overcoming the potential problem of multiplexing associated with ELISA (i.e., the limited number of discriminatory signals), are restricted in use to only detecting nucleic acid. Therefore, agents such as proteins, drugs, hormones, chemical toxins, and prions, which do not contain nucleic acids, cannot be detected by these nucleic acid hybridization techniques. An ideal multiplex detection assay would combine the versatility of antibody recognition with the multiplexing capability and speed of controlled electrochemical detection of nucleic acid hybridization. The present invention provides apparatus and methods of use thereof for performing such an assay.

### SUMMARY OF THE INVENTION

The present invention solves the problem of quick and accurate detection of a target agent by combining the versatility of antibody recognition with the speed and sensitivity of electrochemical nucleic acid detection, yet eliminating the need for nucleic acid isolation/amplification and the problems associated with non-specific nucleic acid hybridization. Non-specific hybridization observed in other diagnostic methods currently known in the art is overcome by nucleic acid sequences that are rationally designed to minimize the risk of non-specific hybridization, ensuring that sequence-specific hybridization is optimized.

Thus, in one aspect, the present invention provides a three dimensional array or “chip” for detecting target agents comprising a support having two opposing surfaces, a plurality of pins projecting from at least one of the two opposing surfaces, wherein each pin comprises a surface with an array associated universal oligo disposed thereon. In certain embodiments, the three dimensional array has a plurality of pins projecting from both opposing surfaces of the support, wherein each pin comprises a surface having an electrodal compound disposed thereon, and further comprising a linking agent linked to said electrodal compound with array associated universal oligos linked to the electrodal compound via the linking agent. In preferred embodiments, the electrodal compound is gold layered over titanium, the linking agent is linked to the electrodal compound via a sulfur linkage, and the linking agent is capable of forming a self-assembling monolayer.

One aspect of the invention provides methods for using a universal array in the detection of one or more target agents. In one embodiment this aspect, a universal oligo array is used in a method of detecting the presence of target agents in a sample. This embodiment includes the use of (1) a array-associated universal oligo, (2) a capture-associated universal oligo that is complementary to the array-associated universal oligo, where the capture-associated universal oligo is conjugated to one or more capture moieties specific for the target agent(s) to be detected, (3) immobilized binding partners to the one or more capture moieties, and (4) a sample suspected of containing the target agents(s). The method includes mixing the sample suspected of containing the target agents(s) with -the capture-associated universal oligo to allow the one or more capture moieties to bind the target agent(s) to form a mixture. The mixture is then contacted with immobilized binding partners to the one or more capture moieties. The unreacted capture moieties can react with the immobilized binding partners, thereby removing unreacted capture-associated universal oligos from solution. The resultant solution is then contacted with the array-associated universal oligo attached to a three dimensional array, where a hybridization event between the array-associated universal oligo and the capture-associated universal oligo indicates that one or more target agents were present in the sample. The hybridization event may be detected by, e.g., electrochemical, fluorescent, or chemiluminescent detection or the like. Preferably, the hybridization is detected by electrochemical means.

Alternatively, the present invention provides an embodiment where the reacted capture-associated universal oligo is immobilized. This embodiment includes the use of (1) a array-associated universal oligo, (2) a capture-associated universal oligo that is complementary to the array-associated universal oligo, where the capture-associated universal oligo is conjugated to one or more antibodies specific for the target agent(s) to be detected, (3) immobilized binding partners to the target agents or to the target agent/capture moiety complex, and (4) a sample suspected of containing the target agent(s). The method includes mixing the sample suspected of containing the target agent(s) with the capture-associated universal oligo to allow the one or more capture moieties to bind the target agent(s) to form a mixture. The mixture is then contacted with immobilized binding partners to the target agents or to the target agent/capture moiety complexes. The reacted capture-associated universal oligos react with the immobilized binding partners, thereby removing reacted capture-associated universal oligos from solution. The immobilized reacted capture-associated universal oligos are separated from the unreacted capture-associated universal oligos still in solution. The immobilized reacted capture-associated universal oligos are then released from immobilization, and subsequently contacted with the array-associated universal oligo attached to a three dimensional array, where a hybridization event between the array-associated universal oligo and the capture-associated universal oligo indicates that one or more target antigens were present in the sample. The hybridization event may be detected by, e.g., electrochemical, fluorescent, or chemiluminescent detection or the like. Preferably, the hybridization is detected by electrochemical means.

### DESCRIPTION OF THE FIGURES

FIG. 1 provides a pictorial representation of one embodiment of the three dimensional array in accordance with the present invention.

FIG. 2 provides a flow diagram showing a method for selecting universal oligos and universal oligo sets.

FIG. 3 provides an overview of one embodiment of a method of detection that may be performed with the universal oligo array.

FIG. 4 provides an overview of another embodiment of a method of detection that may be performed with the universal oligo array.

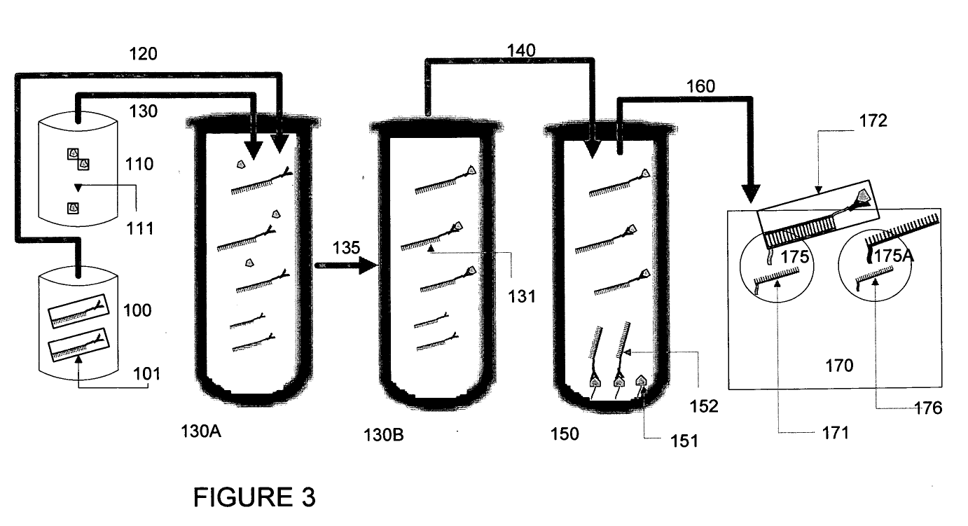

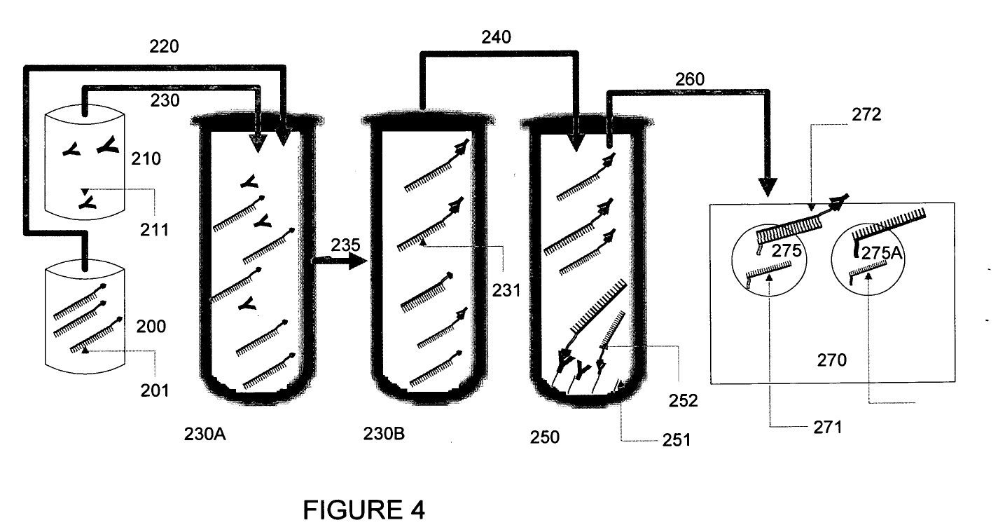

While FIGS. 3 and 4 exemplify an antibody/antigen motif, the principles of the invention are not so limited.

### DEFINITIONS

The terms used herein are intended to have the plain and ordinary meaning as understood by those of ordinary skill in the art. The following definitions are intended to aid the reader in understanding the present invention, but are not intended to vary or otherwise limit the meaning of such terms unless specifically indicated.

The term “nucleic acid molecules” or “oligos” as used herein refers to linear oligomers of natural or modified nucleic acid monomers or linkages, including deoxyribonucleotides, ribonucleotides, anomeric forms thereof, peptide nucleic acid monomers (PNAs), locked nucleotide acid monomers (LNA), and the like, capable of specifically binding to a single stranded polynucleotide by way of a regular pattern of monomer-to-monomer interactions, such as Watson-Crick type of base pairing, base stacking, Hoogsteen or reverse Hoogsteen types of base pairing, or the like. Usually monomers are linked by phosphodiester bonds or analogs thereof to form oligonucleotides ranging in size from a few monomeric units, e.g., 8-12, to several tens of monomeric units, e.g., 100-200. Suitable nucleic acid molecules may be prepared by the phosphoramidite method described by Beaucage and Carruthers (Tetrahedron Lett., 22, 1859-1862, 1981), or by the triester method according to Matteucci, et al. (J. Am. Chem. Soc., 103, 3185, 1981), both incorporated herein by reference, or by other chemical methods such as using a commercial automated oligonucleotide synthesizer.

The terms “complementary” or “complementarity” are used in reference to nucleic acid molecules (i.e., a sequence of nucleotides) that are related by base-pairing rules. Complementary nucleotides are, generally, A and T (or A and U), or C and G. Two single stranded RNA or DNA molecules are said to be substantially complementary when the nucleotides of one strand, optimally aligned and with appropriate nucleotide insertions or deletions, pair with at least about 80% of the nucleotides of the other strand, usually at least about 90% to 95%, and more preferably from about 98 to 100%. Alternatively, substantial complementarity exists when an RNA or DNA strand will hybridize under selective hybridization conditions to its complement. Selective hybridization conditions include, but are not limited to, stringent hybridization conditions. Selective hybridization occurs in one embodiment when there is at least about 65% complementarity over a stretch of at least 14 to 25 nucleotides, preferably at least about 75%, more preferably at least about 90% complementarity. See, M. Kanehisa, Nucleic Acids Res. 12, 203 (1984), incorporated herein by reference. For shorter nucleotide sequences selective hybridization occurs when there is at least about 65% complementarity over a stretch of at least 8 to 12 nucleotides, preferably at least about 75%, more preferably at least about 90% complementarity. Stringent hybridization conditions will typically include salt concentrations of less than about 1 M, more usually less than about 500 mM and preferably less than about 200 mM. Hybridization temperatures can be as low as 5° C. and are preferably lower than about 30° C. However, longer fragments may require higher hybridization temperatures for specific hybridization. Hybridization temperatures are generally at least about 2° C. to 6° C. lower than melting temperatures (Tₘ), which is defined below.

The term “universal oligo” generally refers to one oligonucleotide of a complementary oligonucleotide pair, where each oligonucleotide in the pair has been rationally designed to have low complementarity to sequences that may be present in a sample. For example, in a blood sample for diagnosis of hepatitis in a human, a universal oligo would be one with low complementarity to human genomic sequences, genomic sequences from hepatitis viruses, as well as genomic sequences of organisms that associate with humans (e.g., human gut flora). For a soil sample, a universal oligo would be one with minimal complementarity to genomic sequences from, e.g., soil flora and fauna. A “universal oligo set” is a set of two or more universal oligo pairs where each oligo in the set has low complimentarily to every other universal oligo in the set, with the exception of its complement. A “universal oligo chip” or “universal oligo array” is an array of two or more universal oligos—each from a different universal oligo pair—that are immobilized at a known location on a surface such as glass, plastic, nylon, silicon, etc. The term “capture-associated universal oligo” refers to the oligo of a universal oligo pair that is associated with a capture moiety. The term “array-associated universal oligo” refers to the oligo of a universal oligo pair that is associated with (immobilized on) an array or chip, and in some embodiments, on a three dimensional array. In most embodiments of the present invention, capture-associated universal oligos and array-associated universal oligos are complementary.

A “capture moiety” refers to a portion of a molecule that can be used to preferentially bind and separate a molecule of interest (a “target agent”) from a sample. The term “capture moiety” as used herein refers to any molecule, natural, synthetic, or recombinantly produced, with the ability to bind to the target agent in the methods of the present invention. The binding affinity of the capture moiety must be sufficient to allow collection of the target agent from a sample. Suitable capture moieties include, but are not limited to, antibodies, antigen-binding regions of antibodies, antigens, epitopes, cell receptor ligands, such as peptide growth factors (see, e.g., Pigott and Power (1993), The Adhesion Molecule Facts Book (Academic Press New York); and Receptor Ligand Interactions: A Practical Approach, Rickwood and Hames (series editors) Hulme (ed.) (IRL Press at Oxford Press NY)). Similarly capture moieties may also include but are not limited to toxins, venoms, intracellular receptors (e.g., receptors which mediate the effects of various small ligands, including steroids, hormones, retinoids and vitamin D, peptides), drugs (e.g., opiates, steroids, etc.), lectins, sugars, oligosaccharides, other proteins, and phospholipids. Those of skill in the art readily will appreciate that a number of capture moieties based upon other molecular interactions than those listed above are well described in the literature and may also serve as capture moieties.

By “preferentially binds” it is meant that a capture moiety is designed to be at least 20 times or more, preferably 50 times or more, more preferably 100 times or more, and even more preferably 1000 times or more likely to bind to the intended target agent than to other molecules in a biological solution. Binding will be recognized as existing when the Kₐ is at 10⁷ l/mole or greater, preferably 10⁸ l/mole or greater. In the embodiment where the capture moiety is comprised of antibody, the binding affinity of 10⁷ l/mole or more may be due to (1) a single monoclonal antibody (i.e., large numbers of one kind of antibody) or (2) a plurality of different monoclonal antibodies (e.g., large numbers of each of five different monoclonal antibodies) or (3) large numbers of polyclonal antibodies. It is also possible to use combinations of (1)-(3). The four-fold differential in binding affinity may be accomplished by using several different antibodies as per (1)-(3) above and as such some of the antibodies in a mixture could have less than a four fold difference. For purposes of the invention an indication that no binding occurs means that the equilibrium or affinity constant Kₐ is 10⁶ l/mole or less. Antibodies may be designed to maximize binding to the intended antigen by designing the peptides to specific epitopes that are more accessible to binding, as can be predicted by one skilled in the art.

A “target agent” is the target moiety in a sample that is to be captured through preferential binding with the capture moiety. For example, in the case where the capture moiety is an antibody, the target agent will be any molecule which contains the epitope against which the antibody is generated. Where the capture moiety is a protein used for detection of an antibody, the antibody itself is the target agent. Target agents include organic and inorganic molecules, including biomolecules. In some embodiments, the target agent may be an environmental pollutant (including pesticides, insecticides, toxins, etc.); a chemical (including solvents, organic materials, etc.); therapeutic molecules (including therapeutic and abused drugs, antibiotics, etc.); biomolecules (including hormones, cytokines, proteins, lipids, carbohydrates, cellular membrane antigens and receptors (neural, hormonal, nutrient, and cell surface receptors) or their ligands, etc); whole cells (including procaryotic (such as pathogenic bacteria) and eucaryotic cells, including mammalian tumor cells); viruses (including retroviruses, herpesviruses, adenoviruses, lentiviruses, etc.); and spores; etc.

The term “sample” in the present specification and claims is used in its broadest sense and can be, by non-limiting example, any sample that is suspected of containing the target agents to be detected. It is meant to include a specimen or culture taken from a source suspected of harboring a target agent. Biological samples may include, but are not limited to, sputum, amniotic fluid, whole blood, blood cells (e.g., white cells), blood serum, urine, semen, peritoneal fluid, pleural fluid, pericardial fluid, feces, ascetic fluid, spinal fluid, synovial fluid, tissue or fine needle biopsy samples, and tissue homogenates. Samples may also include sections of tissues such as frozen sections taken for histological purposes. Environmental samples can include environmental material such as surface matter, soil, water, air and industrial samples, as well as samples obtained from food and dairy processing instruments, apparatus, equipment, utensils, disposable and non-disposable items. These examples are not to be construed as limiting the sample types applicable to the present invention. Those of skill in the art would appreciate and understand the particular type of sample required for the detection of particular target antigens.

The term “antibody” as used herein refers to an entire immunoglobulin or antibody or any functional fragment of an immunoglobulin molecule which is capable of specific binding an antigen. Antibody as used herein is meant to include the entire antibody as well as any antibody fragments capable of binding the antigen or antigenic fragment of interest. Examples of such peptides include complete antibody molecules, antibody fragments, such as Fab, F(ab′)₂, CDRS, V_{L}, V_{H}, and any other portion of an antibody which is capable of specifically binding to an antigen. An IgG antibody molecule is composed of two light chains linked by disulfide bonds to two heavy chains. The two heavy chains are, in turn, linked to one another by disulfide bonds in an area known as the hinge region of the antibody. A single IgG molecule typically has a molecular weight of approximately 150-160 kD and containing two antigen binding sites. An F(ab′)₂ fragment lacks the C-terminal portion of the heavy chain constant region, and has a molecular weight of approximately 110 kD. It retains the two antigen binding sites and the interchain disulfide bonds in the hinge region, but it does not have the effector functions of an intact IgG molecule. An F(ab′)₂ fragment may be obtained from an IgG molecule by proteolytic digestion with pepsin at pH 3.0-3.5 using standard methods such as those described in Harlow and Lane, supra. Preferred antibodies for assays of the invention are immunoreactive or immunospecific for, and therefore specifically and selectively bind to, the target agent(s) of interest. A “purified antibody” refers to that which is sufficiently free of other proteins, carbohydrates, and lipids with which it is naturally associated.

A substance is commonly said to be present in “excess” or “molar excess” relative to another component if that component is present at a higher molar concentration than the other component. Often, when present in excess, the component will be present in at least a 10-fold molar excess and commonly at 100-1,000,000 fold molar excess. Those of skill in the art would appreciate and understand the particular degree or amount of excess preferred for any particular reaction or reaction conditions. Such excess is often empirically determined and/or optimized for a particular reaction or reaction conditions.

The term “reacted nucleic acid molecules” or “reacted molecules” is used in reference to those nucleic acid molecules that have a conjugated capture moiety for a particular target agent, where the target agent is present in the sample, and the corresponding capture moiety has bound to the target agent. The term “unreacted nucleic acid molecules” or “unreacted molecules” is used in reference to those nucleic acid molecules that have a conjugated capture moiety for a particular target agent, but the target agent was not present in the sample—or was present in an amount less than the capture moiety—and the corresponding capture moiety has not bound the particular target agent.

The term “capture reaction” is commonly used in reference to the mixing/contacting of the nucleic acid molecules conjugated to a capture moiety and the sample under conditions that allow the capture moiety to attach to, bind or otherwise associate with target agent in the sample.

The term “melting temperature” or Tm is commonly defined as the temperature at which a population of double-stranded nucleic acid molecules becomes half dissociated into single strands. The equation for calculating the Tm of nucleic acids is well known in the art. As indicated by standard references, a simple estimate of the Tm value may be calculated by the equation: Tm=81.5+16.6(log₁₀[Na⁺])0.41(%[G+C])-675/n-1.0m, when a nucleic acid is in aqueous solution having cation concentrations of 0.5 M, or less, the (G+C) content is between 30% and 70%, n is the number of bases, and m is the percentage of base pair mismatches (see e.g., Sambrook J et al., Molecular Cloning, A Laboratory Manual, 3^{rd} Edition, Cold Spring Harbor Laboratory Press (2001)). Other references include more sophisticated computations, which take structural as well as sequence characteristics into account for the calculation of Tm.

The term “matrix” means any surface.

A “restriction endonuclease” is any enzyme capable of recognizing a specific sequence (the “restriction site”) on a double- or, preferably, single-stranded polynucleotide and cleaving the polynucleotide at or near the site. Examples of site-specific restriction endonucleases are available in the 2006 New England Biolabs, Inc. Catalog, including the 2006 New Products Catalog Supplement, which is incorporated herein by reference.

It should be understood by those skilled in the art that terms such as “target”, “agent”, “moiety”, “antigen”, “antibody”, “molecule” and the like should be interpreted in the context in which they appear, and should be given the broadest interpretation possible unless specifically indicated.

### DETAILED DESCRIPTION OF THE INVENTION

The present invention relates to apparatus and method of use thereof for detecting target agents using a three dimensional array.

Sample Processing

An initial step in the methods of the present invention involves obtaining and processing a sample suspected of containing a target antigen(s). Biological samples may include, but are not limited to, sputum, amniotic fluid, whole blood, blood cells (e.g., white cells), blood serum, urine, semen, peritoneal fluid, pleural fluid, pericardial fluid, feces, ascetic fluid, spinal fluid, synovial fluid, tissue or fine needle biopsy samples, and tissue homogenates. Samples may also include sections of tissues such as frozen sections taken for histological purposes. Environmental samples can include environmental material such as surface matter, soil, water, air and industrial samples, as well as samples obtained from food and dairy processing instruments, apparatus, equipment, utensils, disposable and non-disposable items. Sample collection and preparation techniques are well known in the art (see, e.g., Tietz Textbook of Clinical Chemistry and Molecular Diagnostics, 4^{th} Ed., Chapter 2, Burtis, C. Ashwood E. and Bruns, D, eds. (2006); Chemical Weapons Convention Chemicals Analysis: Sample Collection, Preparation and Analytical Methods, Mesilaakso, M., ed., (2005); Pawliszyn, J., Sampling and Sample Preparation for Field and Laboratory, (2002); Venkatesh Iyengar, G., et al., Element Analysis of Biological Samples: Principles and Practices (1998); Drielak, S., Hot Zone Forensics: Chemical, Biological, and Radiological Evidence Collection (2004); Wells, D., High Throughput Bioanalytical Sample Preparation (Progress in Pharmaceutical and Biomedical Analysis) (2002); and Nielsen, D. M., Practical Handbook of Environmental Site Characterization and Ground-Water Monitoring (2005)).

Capture Moieties

In the present invention, “capture moiety” refers to a portion of a molecule that can be used to preferentially bind and separate a molecule of interest (a “target agent”) from a sample, including, but not limited to, antibodies, antigen-binding regions of antibodies, antigens, epitopes, cell receptor ligands, such as peptide growth factors, toxins, venoms, intracellular receptors, drugs, lectins, sugars, oligosaccharides, other proteins, and phospholipids.

In some embodiments, antibodies are used as capture moieties, preferably monoclonal antibodies are used. Monoclonal antibodies of the present invention include a natural monoclonal antibody prepared by immunizing mammals such as mice, rats, hamsters, guinea pigs or rabbits with a target agent (including natural, recombinant, and chemically synthesized proteins, cell culture supernatant), or another immunogenic target agent-associated compound, or a portion thereof; a chimeric antibody or a humanized antibody produced by recombinant technology; or a human monoclonal antibody, for example, obtained by using human antibody-producing transgenic animals. Monoclonal antibodies include those having any one of the isotypes of IgG, IgM, IgA (IgA1 and IgA2), IgD, or IgE. IgG (IgG1, IgG2, IgG3, and IgG4, preferably IgG2 or IgG4) or IgM is preferable. IgG is most preferred.

Polyclonal antibodies or monoclonal antibodies of the present invention can be produced by known methods. Typically, mammals, preferably, mice, rats, hamsters, guinea pigs, rabbits, cats, dogs, pigs, goats, horses, or cows, or more preferably, mice, rats, hamsters, guinea pigs, or rabbits, are immunized with a target antigen along with Freund's adjuvant, if necessary. In addition, transgenic animals may be generated so as to produce an antibody derived from another animal species, such as a human antibody-producing transgenic mouse.

Specifically, a monoclonal antibody can be produced in the following manner by methods well known in the art (see, e.g., Cellular and Molecular Immunology, 5^{th} Ed., Abbas, A. and Lichtman, A. eds. (2005)). Immunizations are done by introducing a chosen target antigen once or several times, subcutaneously, intramuscularly, intravenously, through the footpad, or intraperitoneally, into non-human mammals. Usually, immunizations are performed once to four times every one to fourteen days after the first immunization. Antibody-producing cells are obtained from the mammal in about one to five days after the last immunization. The times and interval of the immunizations can be altered in accordance with the properties of the immunogen used.

Hybridomas that secrete a monoclonal antibody can be prepared by the method of Kohler and Milstein (Nature, Vol. 256, p. 495-97(1975)) and by modified methods known in the art. Hybridomas are prepared by fusing the antibody-producing cells obtained from the spleen, lymph node, bone marrow, or tonsil from the non-human mammal immunized as mentioned above with mammal-derived myelomas that have no auto antibody-producing ability. For example, mouse-derived myelomas P3/X63-AG8.653 (653, ATCC No. CRL1580), P3/NSI/1-Ag4-1 (NS-1), P3/X63-Ag8.U1 (P3U1), SP2/0-Ag14 (Sp2/0, Sp2), PAI, F0, or BW5147; rat-derived myelomas 210RCY3-Ag.2.3; or human-derived myelomas U-266AR1, GM1500-6TG-A1-2, UC729-6, CEM-AGR, D1R11, or CEM-T15 can be used as a myelomas for the cell fusion. Monoclonal antibody producing cells (i.e., the hybridomas) can be screened by cultivating the cells, for example, in microtiter plates, and by measuring the reactivity of the culture supernatant by using the immunogen used for the immunization in an enzyme immunoassay such as an ELISA. The monoclonal antibodies may be produced from hybridomas by cultivating the hybridomas in vitro or in vivo such as in ascites of mice, rats, guinea pigs, hamsters, or rabbits, preferably mice or rats, and isolating the antibodies from the resulting the culture supernatant or ascites fluid. In addition, monoclonal antibodies may be obtained in a large quantity by cloning a gene encoding a monoclonal antibody from a hybridoma or recombinant monoclonal antibody producing cell, generating transgenic animals such as cows, goats, sheep, or pigs in which the gene encoding the monoclonal antibody is integrated using transgenic animal generating techniques, and recovering the monoclonal antibody from the milk of the transgenic animals (Nikkei Science, No. 4, pp. 78-84 (1997)). Cultivating hybridomas in vitro typically is performed by using known nutrient media or nutrient media derived from known basal media. Examples of basal media are low calcium concentration media such as Ham F12 medium, MCDB153 medium, or low calcium concentration MEM medium, and high calcium concentration media such as MCDB104 medium, MEM medium, D-MEM medium, RPMI1640 medium, ASF104 medium, or RD medium. The basal media may also contain, for example, sera, hormones, cytokines, and/or various inorganic or organic substances known in the art.

Monoclonal antibodies can be isolated and purified from the culture supernatant or ascites mentioned above by saturated ammonium sulfate precipitation, euglobulin precipitation, the caproic acid or caprylic acid method, ion exchange chromatography (DEAE or DE52), or by affinity chromatography using anti-immunoglobulin column or protein A column. By using the above-mentioned methods, it is possible to immunize non-human mammals, prepare and screen hybridomas producing the antibodies, and prepare the human monoclonal antibody in large quantities (Nature Genetics, Vol. 7, p. 13-21, 1994; Nature Genetics, Vol. 15, p. 146-156, 1997; Published Japanese Translation of PCT International Publication No. Hei 4-504365; Published Japanese Translation of PCT International Publication No. Hei7-509137; Nikkei Science, June edition, p. 40-50, 1995; WO94/25585; Nature, Vol. 368, p. 856-859, 1994; Published Japanese Translation of PCT International Publication No. Hei 6-500233, etc.).

The monoclonal antibody of the present invention also includes an antibody that comprises the heavy chain and/or the light chain in which either or both of the chains have deletions, substitutions or additions of one or several amino acids in the sequences thereof; several amino acids as referred to here means multiple amino acid residues, specifically means one to ten amino acid residues, preferably one to five amino acid residues. Such a partial modification of amino acid sequence (deletion, substitution, insertion, and addition), can be introduced into the antibody by partially modifying the nucleotide sequence encoding the amino acid sequence. The partial modification of the nucleotide sequence can be performed by the usual method of site-specific mutagenesis (see PNAS USA, Vol. 81, p. 5662-5666 (1984)) or other methods known in the art.

An “antibody” of the present invention includes a portion of an antibody as well, including F(ab′)₂, Fab′, Fab, Fv (variable fragment of antibody), sFv, dsFv (disulfide stabilized Fv), or dAb (single domain antibody). F(ab′)₂ and Fab′ can be produced by digesting an antibody near the disulfide bonds existing between the hinge regions in each of the two H chains with a protease such as pepsin and papain, generating an antibody fragment. For example, papain cleaves IgG upstream of the disulfide bonds existing between the hinge regions in each of the two H chains to generate two homologous antibody fragments in which an L chain composed of V_{L} (L chain variable region) and C_{L} (L chain constant region), and an H chain fragment composed of V_{H} (H chain variable region) and C_{H}γ1 (gammal region in the constant region of H chain) are connected at their C terminal regions through a disulfide bond. Each of these two homologous antibody fragments is called Fab′. Pepsin also cleaves IgG downstream of the disulfide bonds existing between the hinge regions in each of the two H chains to generate an antibody fragment slightly larger than the fragment in which the two above-mentioned Fab′ are connected at the hinge region. This antibody fragment is called F(ab′)₂.

Antibodies generated by the methods described herein may be characterized by an immunoassay such as the single antibody solid phase method, two-antibody liquid phase method, two-antibody solid phase method, sandwich method, enzyme multiplied immunoassay technique (EMIT method), enzyme channeling immunoassay, enzyme modulator mediated enzyme immunoassay (EMMIA), enzyme inhibitor immunoassay, immuno-enzymometric assay, enzyme-enhanced immunoassay or proximal linkage immunoassay, all of which are described in Enzyme Immunoassay, 3rd Ed., Eiji Ishikawa et al., and Igakushoin eds., (1987)); or the one-pot method which is described in JP-B Hei 2-39747. However, from the standpoint of simplicity of operation and/or economical advantage, and especially when considering the clinical applicability of the monoclonal antibody, the sandwich method, the one pot method, the single antibody solid phase method or the two-antibody solid phase method are preferably used. Most preferable is the sandwich method using a labeled antibody prepared by labeling an antibody generated with an enzyme or biotin and using an antibody-immobilized insoluble carrier prepared by immobilizing the monoclonal antibody on a multi-well microplate.

Universal Oligo Sets and Universal Oligo Arrays

The universal oligos of the present invention are oligonucleotides from a complementary oligonucleotide pair, where each oligo in the pair has been rationally designed to have low complementarity to sequences that may be present in a given sample. A “universal oligo set” is a set of two or more universal oligo pairs where each oligo in the set has low complimentarity to every other universal oligo in the set, with the exception of its complement. Use of universal oligo arrays for detecting target agents has many advantages. For example, the universal oligo arrays can be used with virtually any downstream application (i.e., the front end assay can detect antibodies, antigens, chemical or biological toxins, pathogenic agents, drugs, drug metabolites, other metabolites, environmental contaminants, etc.), yet the arrays have standardized hybridization conditions independent of the target agent. However, the universal oligo arrays can be flexible as well, as different universal oligo sets may be used for different assays, where a particular universal oligo chip may have array-associated oligos with melting temperatures and/or lengths of X and another universal oligo chip may have array-associated oligos with melting temperatures and/or lengths of Y. In addition, the universal oligos of the present invention can be engineered to contain sequences for enzyme cleavage for use in some embodiments.

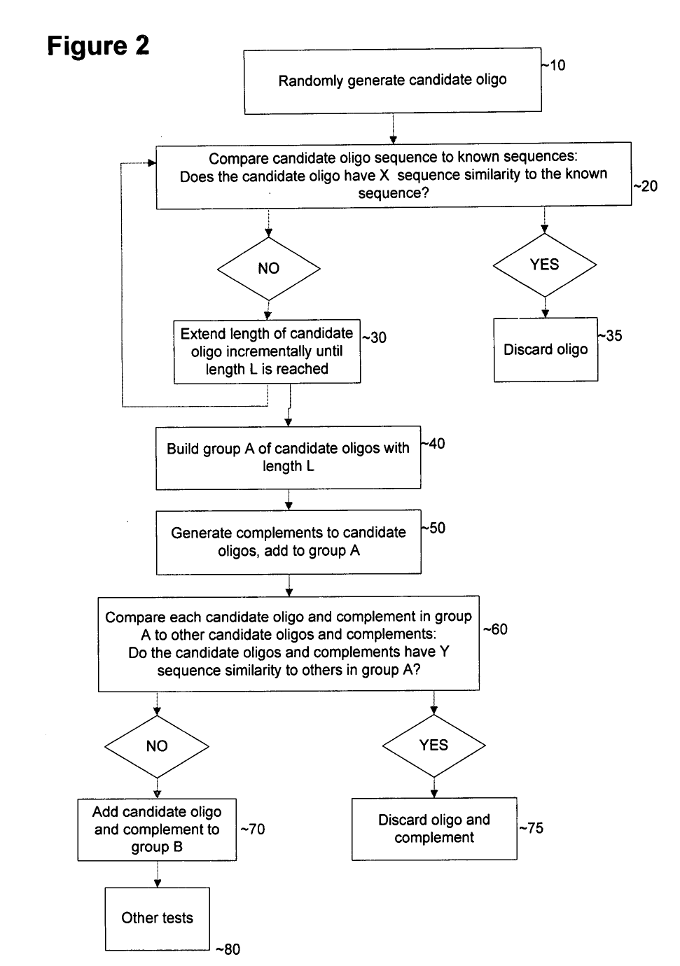

FIG. 2 is a flow chart showing the steps of creating universal oligos and a universal oligo set. In step 10, candidate oligo sequences are randomly generated. Typically, such randomly generated sequences will be short, for example, 8-25 nucleotides in length. In one embodiment of the invention, all possible variations of 15-mers (consisting only nucleotides A, T, G and C) are generated and stored in a database. At step 20, each candidate sequence is compared to known sequences, typically, by comparing the candidate sequence to sequences stored in publicly-available and/or custom databases. Custom databases may be databases populated with information from publicly-available databases. Major publicly-available sequence repositories include DDBJ: DNA databank of Japan, EMBL: maintained by EMBL, and GenBank: maintained by NCBI; organelle databases include OGMP: the organelle genome megasequencing program, GOBASE: an organelle genome database, and MitoMap: a human mitochondrial genome database; RNA databases include Rfam: an RNA familiy database, RNA base: a database of RNA structures, tRNA database: a database of tRNAs, tRNA: tRNA sequences and genes, and sRNA: a small RNA database; comparative and phylogenetic databases include COG: phylogenetic classification of proteins, DHMHD: a human-mouse homology database, HomoloGene: a database of gene homologies across species, Homophila: a human disease to Drosophila gene database, HOVERGEN: a database of homologous vertebrate genes, TreeBase: a database of phylogenetic knowledge, XREF: a database that cross-references human sequences with model organisms; SNP, mutation and variation databases include ALPSbase: a database of mutations causing human ALPS, dbSNP: the single nucleotide polymorphism database at NCBI, and HGVbase: a human genome variation database; alternative splicing databases include ASDB: a database of alternatively spliced genes, ASAP: an alternate splicing analysis tool, ASG: an alternate splicing gallery, HASDB: a human alternative splicing database, AsMamDB: a database of alternatively spliced genes in human, mouse and rat, and ASD: an alternative splicing database at CSHL; and scores of specialized databases include ACUTS: a database of ancient conserved untranslated sequences, AGSD: an animal genome database, AmiGO: a gene ontology database, ARGH: an acronym database, BACPAC: BAC and PAC a database of genomic DNA library info, CHLC: a database of genetic markers on chromosomes, COGENT: a complete genome tracking database, COMPEL: a database of composite regulatory elements in eukaryotes, CUTG: a codon usage database, dbEST: a database of expressed sequences or mRNA, dbGSS: genome survey sequence database, dbSTS: a database of sequence tagged sites (STS), DBTSS: a database of transcriptional start sites, DOGS: a database of genome sizes, EID: the exon-intron database, Exon-Intron: an exon-intron database, EPD: a eukaryotic promotor database, FlyTrap: a HTML-based gene expression database, GDB: the genome database, GeneKnockouts: a database of gene knockout information, GENOTK: a human cDNA database, GEO: a gene expression omnibus NCBI, GOLD: a database of information on genome projects around the world, GSDB: the Genome Sequence DataBase, HGI: TIGR human gene index, HTGS: a database of genomic sequences at NCBI, IMAGE: a database of the largest collection of DNA sequences clones, IMGT: a database of the international ImmunoGeneTics information system, LocusLink: single query interface to sequence and genetic loci , TelDB: ae telomere database, MitoDat: a database of mitochondrial nuclear genes, Mouse EST: a database with information from the NIA mouse cDNA project, MPSS: searchable databases of several species, NDB: a nucleic acid database, NEDO: a human cDNA sequence database, NPD: a nuclear protein database, PLACE: a database of plant cis-acting regulatory DNA elements, RDP: a ribosomal database, RDB: a receptor database at NIHS, Japan, Refseg: the NCBI reference sequence project, RHdb: a database of radiation hybrid physical map of chromosomes, SpliceDB: a database of canonical and non-canonical splice site sequences, STACK: a database of consensus human EST database, TAED: the adaptive evolution database, TIGR: curated databases of microbes, plants and humans, TRANSFAC: the transcription factor database, TRRD: a transcription regulatory region database, UniGene: a database of cluster of sequences for unique genes at NCBI, and UniSTS: a database of nonredundent STS.

For sequence comparison, known sequences act as reference sequences to which the candidate sequences are compared. When using a sequence comparison algorithm, known and candidate sequences are input into a computer, subsequence coordinates are designated if appropriate, and sequence algorithm program parameters are designated. The sequence comparison algorithm then calculates the percent sequence identity or regions of sequence identity for the candidate sequence relative to the known reference sequence, based on the designated program parameters.

The determination of percent identity between two or more sequences can be accomplished using a mathematical algorithm. Preferred, non-limiting examples of such mathematical algorithms are the algorithm of Myers and Miller (1988); the search-for-similarity-method of Pearson and Lipman (1988); and that of Karlin and Altschul (1993). Preferably, computer implementations of these mathematical algorithms are utilized. Such implementations include, but are not limited to: CLUSTAL in the PC/Gene program (available from Intelligenetics, Mountain View, Calif.); the ALIGN program (Version 2.0), GAP, BESTFIT, BLAST, FASTA, Megalign (using Jotun Hein, Martinez, Needleman-Wunsch algorithms), DNAStar Lasergene (see www.dnastar.com) and TFASTA in the Wisconsin Genetics Software Package, Version 8 (available from Genetics Computer Group (GCG), 575 Science Drive, Madison, Wis., USA). Alignments using these programs can be performed using the default parameters or parameters selected by the operator. The CLUSTAL program is well described by Higgins. The ALIGN program is based on the algorithm of Myers and Miller; and the BLAST programs are based on the algorithm of Karlin and Altschul. Software for performing BLAST analyses is publicly available through the National Center for Biotechnology Information (http://www.ncbi.nlm.nih.gov/).

If a candidate sequence is found to have sequence similarity above a given limit (however this limit is defined, e.g., X % homology overall or a percentage over a stretch of a sequence) during the screening against known sequences, the candidate sequence will be discarded (step 35). If a candidate sequence is found to have sequence homology below a given limit during the screening against known sequences, the candidate sequence will be extended by one or more nucleotides (step 30) and will go through the screening process again.

In a preferred embodiment, the candidate sequence will be extended by one nucleotide at a time (step 30), but will be extended by each of A, T, G and C. For example, if candidate sequence XXXXXXXXXXXXXXX is determined to have sequence homology below the given limit, candidate sequence XXXXXXXXXXXXXXX will then be extended by one nucleotide four times, that is, candidate sequence XXXXXXXXXXXXXXX will be extended to candidate sequence XXXXXXXXXXXXXXXA, candidate sequence XXXXXXXXXXXXXXXT, candidate sequence XXXXXXXXXXXXXXXG and candidate sequence XXXXXXXXXXXXXXXC and each of these candidate sequences will be screened as described previously (step 20). The process continues until a length L is achieved. Once a candidate sequence of length L is found, it is placed in a group A of candidate sequences (step 40), and these candidate sequences are used to build a universal oligo set.

In building a universal oligo set, sequences complementary to the candidate sequences are generated and added to the candidate sequences in group A (step 50). At step 60, each candidate sequence and complement in group A are compared to each other candidate sequence and each other complement to determine the extent of sequence similarity (however “sequence similarity” is defined). If a candidate or complement sequence is found to have sequence similarity above a given limit (again, however “sequence similarity” is defined) during the screening at step 60, the candidate sequence and its complement will be discarded (step 75). If it is determined that a candidate sequence and its complement are found to have sequence homology below a given limit during the screening at step 60, the candidate sequence and complement will be added to a group B (step 70). The candidate and complementary sequences in group B may then be subjected to further screening (step 80), using various parameters such as melting temperature (Tm), existence of duplexes, specificity of hybridization, existence of a GC clamp, existence of hairpins, existence of sequence repeats, dissociation minimum for a 3′ dimer, dissociation minimum for the 3′ terminal stability range, frequency threshold, or maximum length of acceptable dimers and the like.

The universal oligos can be 1 to 10000 bases in length, preferably 10 to 1000 bases in length, more preferably 10-500 bases in length and more preferably about 25 to about 100 bases in length. Additionally, the universal oligos may be DNA, RNA or PNA (peptide nucleic acid) and can include non-naturally occurring subunits, sequences and/or moieties. PNA includes peptide nucleic acid analogs. The backbones of PNA are substantially non-ionic under neutral conditions, in contrast to the highly charged phosphodiester backbone of naturally occurring nucleic acids. This results in two advantages. First, the PNA backbone exhibits improved hybridization kinetics. PNAs have larger changes in the melting temperature (Tm) for mismatched versus perfectly matched basepairs. DNA and RNA typically exhibit a 2-4° C. drop in Tm for an internal mismatch. With the non-ionic PNA backbone, the drop is closer to 7-9° C. This allows for better detection of mismatches. Similarly, due to their non-ionic nature, hybridization of the bases attached to these backbones is relatively insensitive to salt concentration. This is advantageous in certain embodiments, as a reduced salt hybridization solution has a lower Faradaic current than a physiological salt solution (in the range of 150 mM).

Conjugation of the capture-associated universal oligos to the capture moities may be performed in numerous ways, providing it results in a capture moiety possessing both epitope-specific binding to capture the target agent as well as providing it does not restrict nucleic acid hybridization functionalities in embodiments where a cleavage is not performed, to allow detection of the bound target agent. For example, nucleic acid-antibody conjugates can be synthesized by using heterobifunctional cross-linker chemistries to covalently attach single-stranded DNA labels through amine or sulfhydryl groups on an antibody to create a capture agent of the invention (see, e.g., Hendricksen ER, Nucleic Acids Res., 23(3):522-9(1995)). In another example, covalent single-stranded DNA-streptavidin conjugates, capable of hybridizing to complementary surface-bound oligonucleotides, are utilized for the effective immobilization of biotinylated antibodies. Niemeyer C M, et al., Nucleic Acids Res.; 31(16):90 (1995). Many other nucleic acid molecular conjugates are described in Heidel J et al., Adv Biochem Eng Biotechnol.; 99:7-39 (2005). Additional methods of creating antibody-oligo conjugates, both those existing and under development, will be apparent to one skilled in the art upon reading the present disclosure, and such methods are intended to be captured within the methods of the invention.

In accordance with one embodiment of the present invention, one oligo of a universal oligo pair, the array-associated universal oligo, is immobilized (directly or indirectly) onto an electrochemical surface. Although a metal electrode (e.g., gold, aluminum, platinum, palladium, rhodium, ruthenium, any metal or other material having a free electron in its outer most orbital) is preferably employed as the surface for immobilizing the array-associated universal oligo, other surfaces such as photodiodes, thermistors, ISFETs, MOSFETs, piezo elements, surface acoustic wave elements, and quartz oscillators may also be employed. By “electrode” herein is meant a composition, which, when connected to an electronic device, is able to conduct, transmit, receive or otherwise sense a current or charge. This current or charge is subsequently converted into a detectable signal. Alternatively an electrode can be defined as a composition, which can apply a potential to and/or pass electrons to or from a chemical moiety. Preferred electrodes are known in the art and include, but are not limited to, certain metals and their oxides, including gold; platinum; palladium; silicon; aluminum; titanium, metal oxide electrodes including platinum oxide, titanium oxide, tin oxide, indium tin oxide, palladium oxide, silicon oxide, aluminum oxide, molybdenum oxide (Mo₂,O₆), tungsten oxide (WO₃) and ruthenium oxides; carbon (including glassy carbon electrodes, graphite, pyrolytic graphite, carbon fiber, and carbon paste); and semiconductor electrodes, such as Si, Ge, ZnO, CdS, TiO₂ and GaAs. Preferred electrodes include gold, silicon, platinum, carbon and metal oxide electrodes, with gold being particularly preferred. The electrode may also be covered with conductive compounds to enhance the stability of the electrodes immobilized with probes or nonconductive (i.e., insulative materials). Monomolecular films or biocompatible materials may also be employed to coat or partially coat the electrodes.

In one embodiment of the present invention, a three dimensional substrate (e.g., a pin array) is utilized. In contrast to typical DNA arrays comprising DNA spotted onto a flat surface (a planar array), an embodiment of the present invention employs an “array” of small structures (i.e., “pins”) that project from a planar support. While this embodiment is not limited to use in an electrochemical detection method, the following discussion is provided for understanding and is not intended to limit the invention to any particular detection method. All know detection methods (e.g., fluorescence, radioisotope, etc.) can also be employed with the three dimensional array.

To a solid or semisolid support (e.g., polymer, fiber, metal, glass, silicon, etc.), small projections are created. In a preferred embodiment, the projections are comprised of a conductive surface such that it can function in an electron transfer and/or other electrochemical detection method. In a preferred embodiment the projections are similar to the gold pins commonly employed in electronic devices such as the processor chips used for computer CPU chips.

Envisioning the present embodiment where at least one surface of the support resembles the underside of a Pentium chip is helpful in that it provides an analogous concept—gold pins projecting from a support. In one embodiment of the present invention, the pins project though the support from which they project (i.e., project from opposing surfaces of the support) so as to allow the pins to be connected electronically to, for example, a voltammetric device for electrochemical measurement and detection.

In a preferred embodiment, the pins have a gold surface which allows for the facile immobilization of nucleic acid molecules to the surface via, for example, sulfide linkages. The pins can be gold or gold plated onto an acceptable material such as titanium or a titanium coated substrate, or in the case of, for example a polymer pin, the gold can be plated directly onto the pin as described in more detail, infra.

In a preferred embodiment, the pins are contacted with a desired solution containing an oligonucleotide sequence of choice, said oligonucleotides being derivatized in accordance with the methods disclosed herein or any other method know to one of ordinary skill in the art. In a preferred embodiment, the oligonucleotides are derivatized (at either the 3′ and/or 5′ end) with a moiety that allows for the creation of a self-assembling monolayer (SAM). The use of a SAM derivatized oligonuleotide layer is particularly beneficial in the context of electrochemical detection.

The derivatized pin electrode or “array” of pin electodes are then contacted with a sample suspected of containing a target analyte in a methodology that is the same or analogous to the methods of detection described herein utilizing a planar array.

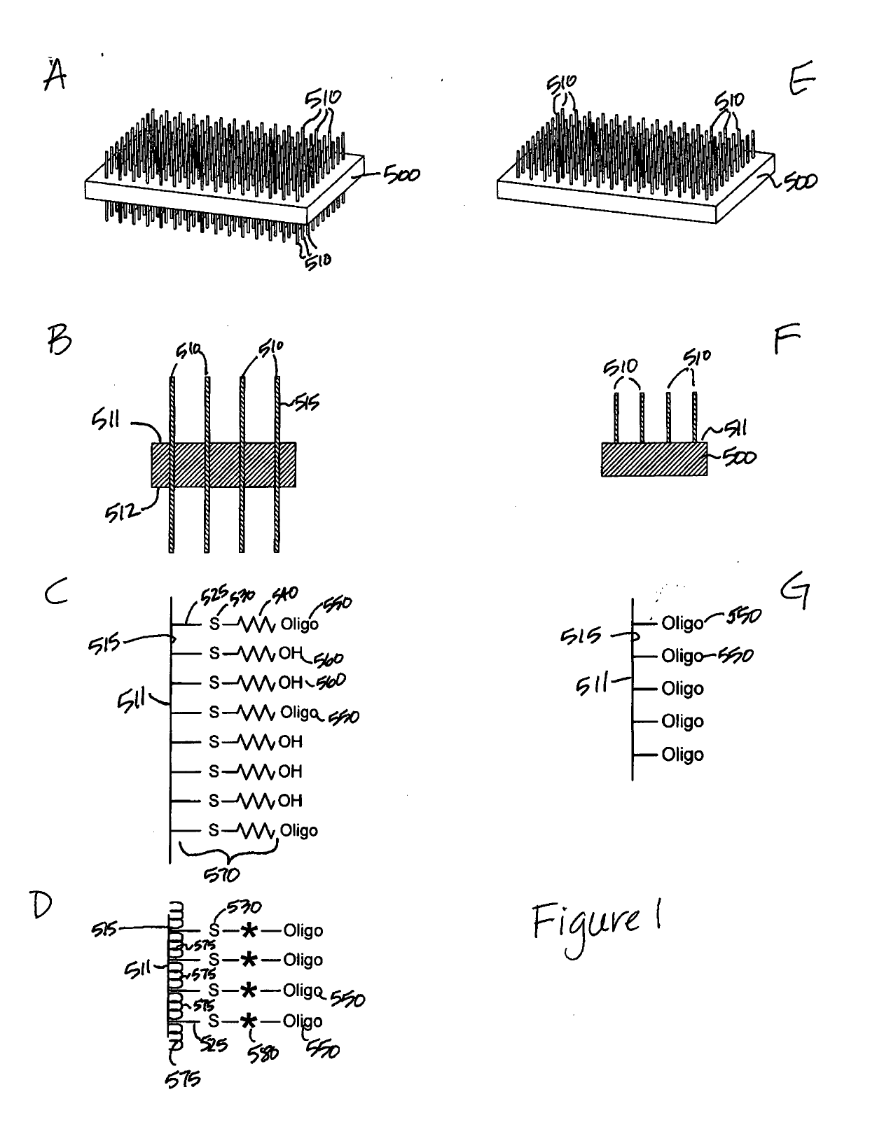

FIG. 1 provides a pictorial representation of two embodiments of the three dimensional arrays of the present invention. In FIG. 1A, a support 500 is seen having a plurality of pins 510 projecting from opposing surfaces of support 500 (or disposed through support 500). The support can comprise a wide variety of materials, as will be appreciated by those in the art, with glass, polymers and printed circuit board (PCB) materials being particularly preferred. Thus, in general, the suitable supports include, but are not limited to, fiberglass, Teflon, ceramics, glass, silicon, mica, plastic (including acrylics, polystyrene and copolymers of styrene and other materials, polypropylene, polyethylene, polybutylene, polycarbonate, polyurethanes, Teflon™, and derivatives thereof, etc.), GETEK (a blend of polypropylene oxide and fiberglass), and other materials typically employed and readily known to those of ordinary skill in the art. FIG. 1B is an enlargement cross section of FIG. 1A, showing pins 510 projecting through support 500. In addition, pins 510 have a surface 515. FIG. 1B also indicates that pins 510 project out of one side 511 of the support and out of the opposing side 512 of the support. The pins seen here are round cylinders, but need not be. Pins 510 may be square, rectangular, hexagonal, etc. projections, or can be hollow cylilnders of various shapes.

FIG. 1C shows the surface 515 of the pin on opposing side 511 of support 500, where the surface 515 comprises an electrodal material such as gold or as described otherwise in detail herein supra, linked via bond 525 to, in this embodiment, a sulfur molecule 530, which is in turn linked to a linker molecule 540, which may further be linked to an array-associated universal oligo 550. In some embodiments, all linker molecules 540 may be linked to an array-associated universal oligo 550, or, as seen here, some linker molecules 540 are linked to array-associated universal oligos 550, where other linker molecules 540 terminate with another chemical entity (here a hydroxyl group 560). In some preferred embodiments, the linker molecules are capable of forming a self-assembling monolayer (SAM) 570. When the surface 515 of the pin 510 on opposing side 511 of support 500 is derivatized with the array-associated universal oligos, the surface 515 of the pin 510 on opposing side 512 of support 500 is not so derivatized. In the case of hollow cylinder-type pins, the inside of the cylinder, the outside of the cylinder or both may be derivatized on opposing side 511, with the surfaces of the hollow cylinder-type pin on opposing side 512 not so derivatized. FIG. 1D shows the surface 515 of a pin, where the surface comprises an electrodal material such as gold as described herein linked via bond 525 to a sulfur molecule 530, which is in turn linked to a linker molecule 580, which is further linked to an array-associated universal oligo 550. In this embodiment, a blocking agent 575 is used to prevent a short in the electrical circuit.

FIG. 1E shows an embodiment of the present invention that may be employed in, e.g., fluorescent, radiological or chemiluminescent embodiments of the present invention. In FIG. 1E, a support 500 is seen having a purality of pins 510 projecting from only one surface of support 500. FIG. 1F is an enlargement cross section of FIG. 1E, showing pins 510 projecting from support 500. In addition, pins 510 have a surface 515. The pins seen here are round cylinders, but need not be. Pins 510 may be square, rectangular, hexagonal, etc. projections. FIG. 1G shows pin surface 515 having array-associated universal oligos 550 attached directly thereto.

Accordingly, in a preferred embodiment, the present invention provides universal oligo arrays that comprise substrates comprising a plurality of pin electrodes, preferably gold, platinum, palladium or semiconductor electrodes. In addition, each pin electrode passes through a support where on one surface of the support, the pins comprise array-associated universal oligos and on the opposing side of the support, the pins are attached to a device that can control the electrode and/or receive the signal transmitted via conductive means in contact with the electrode. That is, each electrode is independently addressable. The support can be part of a larger device comprising a “fish tank” or reaction chamber that exposes a given volume of sample to the surface of the support comprising the pins comprising the array-associated universal oligos. Generally, the reaction chamber ranges from about 1 μl to 1 ml, with about 10 μl to 500 μl being preferred. As will be appreciated by those in the art, depending on the experimental conditions and assay, smaller or larger volumes may be used. The volumes and concentrations employed are typically empirically determines using methods readily known to those of ordinary skill in the art.

In certain embodiments, the reaction chamber and support are part of a cartridge that can be inserted into a device comprising electronic components selected from the group comprising potentiometers, AC/DC voltage source, ammeters, processors, displays, temperature controllers, light sources, and the like. In a typical embodiment, the pins are positioned such that upon insertion of the cartridge into the device, connections between the pins and the electronic components are established such as described previously. The device can also comprise a means for controlling the temperature, such as a peltier block, that facilitates the conditions employed in the hybridization reaction.

In certain preferred embodiments, the electrode is first coated with a biocompatible substance (such as dextran, carboxylmethyldextran, other hydrogels, polypeptides, polynucleotides, biocompatible and/or bio-inert matrices or the like). The array-associated universal oligo is immobilized to such biocompatible substance.

The array-associated universal oligos may be immobilized onto the electrodes directly or indirectly by covalent bonding, ionic bonding and physical adsorption. Examples of immobilization by covalent bonding include a method in which the surface of the electrode is activated and the nucleic acid molecule is then immobilized directly to the electrode or indirectly through a cross linking agent. Yet another method using covalent bonding to immobilize a array-associated universal oligo includes introducing an active functional group into an oligo followed by direct or indirect immobilization. The activation of the surface may be conducted by electrolytic oxidation in the presence of an oxidizing agent, or by air oxidation or reagent oxidation, as well as by covering with a film. Useful cross-linking agents include, but are not limited to, silane couplers such as cyanogen bromide and gamma-aminopropyl triethoxy silane, carbodiimide and thionyl chloride and the like. Useful functional groups to be introduced to the oligo may be, but are not limited to, sulfide, disulfide, amino, amide, amido, a carboxyl, a hydroxyl, carbonyl, oxide, phosphate, sulfate, aldehyde, keto, ester and mercapto groups. Other highly reactive functional groups may also be employed using methods readily known to those of ordinary skill in the art. Preferably, the array-associated universal oligos are derivatized (at either the 3′ or 5′ end) with a moiety that allows for the creation of a self-assembling monolayer.

To detect multiple target agents in a sample, multiple electrodes, or an electrode with multiple array-associated universal oligos attached in a predetermined configuration are employed. In such a configuration, a plurality of electrodes each having a distinct array-associated universal oligo affixed thereto or otherwise associated therewith are arranged in predetermined configuration. In a preferred embodiment, the voltage applied to each electrode is equal. Additionally, to verify the hybridization of a particular array-associated universal oligo, the electrochemical detection device preferably includes a switch circuit, a decoder circuit, and/or, a timing circuit to apply the voltage to the individual electrodes and to receive the output signal from each of the electrodes.

Alternatively, the capture-associated universal oligos and array-associated universal oligos can be used in traditional optical detection methods well known in the art. In this case, the array-associated universal oligos may be synthesized in situ (see, e.g., U.S. Pat. Nos. 5,744,305; 5,753,788; 5,770,456; 5,889,165; 6,346,413; 6,506,558; 6,566,495; and 6,600,031) or by physical spotting of the array-associated universal oligos with the aid of robotic arraying equipment or through electronic addressing on a solid substrate such as glass or by dipping the pins of the three dimensional array of the present invention into arrays wells or containers containing the desired array-associated oligos. Labels are attached to the capture-associated universal oligos (or the capture moiety) and detected with an array reader that quantitates the level of optical activity (typically, fluorescence) and identifies the location of the hybridization event. Typically the reader involves confocal optical detection as discussed infra. In the present embodiment, the label is added directly to the capture-associated universal oligo or to capture moiety. Means of attaching labels to nucleic acids are well known to those of skill in the art and include, e.g., end-labeling by kinasing the universal oligo and subsequent attachment (ligation) of a nucleic acid linker joining the sample nucleic acid to a label (e.g., a fluorophore). Useful labels for this embodiment of the present invention include fluorescent dyes (e.g., fluorescein, texas red, rhodamine, green fluorescent protein, and the like. Patents teaching the use of labels include U.S. Pat. Nos. 3,817,837; 3,850,752; 3,939,350; 3,996,345; 4,277,437; 4,275,149; and 4,366,241.

Assay and Detection

The universal oligos and universal oligo three dimensional arrays are used in a system comprising capture-associated universal oligos, where the capture moiety is, e.g., one or more antibodies specific for target agents. The capture-associated universal oligos are contacted/mixed with a sample that is suspected of containing the target agents, under conditions that if one or more target agents are present, the capture moieties can react with, i.e., bind with/to the target agents. In most embodiments, the capture-associated universal oligos conjugated to the capture moieties are added in excess relative to the amount of target agents suspected to be present in the sample.

In one embodiment, the capture moiety is one or more antibodies specific for target antigens. The immobilized binding partners can be a naturally-occurring or synthetic epitope of the capture moieties. If multiple capture-associated universal oligos are used, each having an antibody specific for a different target antigen or different epitope of the same target antigen, multiple immobilized binding partners are used to facilitate the removal/separation of unreacted capture-associated universal oligos (those with antibodies that did not react with target antigen in the sample). In such a detection method, multiple different target antigens may be screened/detected simultaneously. The advantage of a simultaneous accurate detection method includes an increased speed at which multiple suspected antigens can be eliminated. For example, a patient can provide a sample that can quickly be tested for the presence of multiple suspected target agents (e.g., toxins, strains of bacteria and/or viruses, etc.). Such a rapid and accurate test can aid in the treatment of the condition, e.g., where no bacterial infection is found there is no need to treat with antibiotics. Similarly, improper use of antibiotics can be reduced or eliminated by ensuring that the proper antibiotic, specific for the detected infectious agent, is administered. Additionally, the construction of complete test panels that can be specific for the particular type of sample, or for the particular suspected underlying diseases or agents is another advantage of this particular method. For example, one could construct a test panel for sexually transmitted diseases, another panel for common blood borne diseases, yet another for airborne pathogens, yet another for terrorist agents (biological and/or chemical), yet another for common childhood disease. In another embodiment, the panel is selected so as to provide an indication of the particular strain of one or more pathogenic agents and, in particular, to provide an accurate indication of the proper antibiotic (or other treatment(s)) that is to be administered. For example, a panel of antibody-conjugated capture-associated universal oligos is prepared, wherein the antibodies are monoclonal antibodies capable of distinguishing between various strains of a particular bacterial species (e.g., Staphylococcus aureus) characterized by, inter alia, their resistance to antibiotics (e.g., methicillin-resistant Staphylococcus aureus (MRSA)). Thus, by employing the present invention, a rapid and accurate screen can be performed whereby strains are identified and the proper antibiotic can be administered, resulting in both an effective treatment and a reduction in the overuse and/or improper use of antibiotics.

With these concepts in mind, in one application of one embodiment of the invention, capture-associated universal oligos are conjugated to antibodies and the target agent of interest is one or more target antigens. In accordance with this embodiment the invention the following elements are included: (1) a array-associated universal oligo immobilized on a surface, (2) a capture-associated universal oligo that is complementary to the array-associated universal oligo, where the capture-associated universal oligo is conjugated to an antibody corresponding to the one or more target antigens, (3) immobilized binding partners, and (4) a sample suspected of containing the one or more target antigens. In one aspect, the capture-associated universal oligo is contacted with the sample to form a first mixture, then the first mixture is contacted with the immobilized binding partners of the antibodies. The unreacted capture-associated universal oligos are captured by the immobilized binding partners, thereby removing the unreacted capture-associated universal oligos from solution. The solution phase of the mixture is then contacted with the three dimensional array-associated universal oligos, followed by detection as otherwise described herein. Alternatively, the reacted oligo-antibody-antigen moieties can be immobilized with an immobilized binding partner to the one or more target antigens or to the target antigen/capture moiety complexes, leaving the unreacted oligo-antibody molecules in solution. Other variations on this preferred embodiment include one or more other aspects of the invention described herein or such other modification known to those of ordinary skill in the art.

This embodiment most frequently is employed in a multi-target (so-called multiplexed) format, allowing for the screening of multiple target antigens simultaneously. Such embodiments include providing (1) a detection device comprising array-associated universal oligos, (2) a set of capture-associated universal oligos, (3) a sample suspected of containing target antigens or epitopes, and (4) immobilized binding partners of the antibodies of the capture-associated universal oligos. The method comprises mixing/contacting the sample with the capture-associated universal oligos under reaction conditions that allow the antibodies to capture target antigens present in the sample to form a first mixture. The first mixture is then mixed/contacted with the immobilized binding partners to the antibodies where the antibodies that have not reacted with target antigens in the sample react with the immobilized binding partners to form an immobilized phase and a solution phase. The solution phase comprises the capture-associated universal oligos that have reacted with target antigens in the sample and the immobilized phase comprises the capture-associated universal oligos that did not bind target antigens and instead bound the immobilized binding partners. The solution is introduced to the universal oligo chip and the detection device under conditions such that the capture-associated universal oligos present will hybridize to a complementary array-associated universal oligo, generating a signal.

Alternatively, the reacted capture-associated universal oligo complex can be captured (e.g., by an antibody that recognizes the target antigen or the antibody-target antigen complex) leaving the unreacted capture-associated universal oligo complexes in solution. The immobilized phase is separated, and the reacted capture-associated universal oligo complex is then released into solution and introduced to the universal oligo chip and to the detection device under reaction conditions such that the capture-associated universal oligos and array-associated universal oligos may hybridize to each other. A signal generated by the hybridization of complementary capture-associated universal oligos and array-associated universal oligos.

FIG. 3 shows a sample (110) suspected of having a target antigen (111). The sample is mixed or otherwise contacted with a reagent (100) comprising one or more capture-associated universal oligos (101). In FIG. 3, reagent (100) is added (120) to test tube (130A) and the sample (110) is also added (130) to the test tube (130A). In practice, it is not necessary to use a separate tube (130A), as the sample and reagent can be contacted or mixed in any fashion. After allowing the mixture of reagent (100) and sample (110) to react (time indicated by arrow (135)), the capture-associated universal oligos (101) will bind with the antigen (111) to form a capture-associated universal oligo-antigen complex (131).

In the embodiment shown, the reaction mixture containing capture-associated universal oligo-antigen complex (131) is transferred (140) to a vessel (shown here as test tube (150)), which comprises immobilized antigen (151). Any capture-associated universal oligo (101) that has not formed the capture-associated universal oligo-antigen complex (131) will bind to the immobilized antigen (151), thereby resulting in removal of unreacted capture-associated universal oligos (101) from solution through the formation of immobilized capture-associated universal oligos (152).

The supernatant of the reaction performed in test tube (150) is then transferred (160) to the universal oligo chip (170). The universal oligo chip (170) in this embodiment comprises one or more electrodes (175) on which array-associated universal oligos (171) have been immobilized. Array-associated universal oligo (171) is complementary to a capture-associated universal oligo present in the reagent (101). Hybridization of array-associated universal oligo (171) with the capture-associated universal oligo (131) results in double stranded nucleotide species (172) which is subsequently detected. Also shown are array-associated universal oligos (176) on a separate electrode (175A). In most instances array-associated universal oligo (176) will have a different sequence than array-associated universal oligo (171) mobilized on electrode 175. Both electrodes are utilized if a multiplexed system were employed.

FIG. 4 shows an alternative embodiment of the present invention where a sample (210) suspected of having a target agent is provided. The target agent in this instance is an antibody (211). The sample is mixed or otherwise contacted with a reagent (200) having one or more single stranded oligo-conjugated antigens (201). In FIG. 4, reagent (200) is added (220) to test tube (230A) and the sample (210) is also added (230) to the test tube (230A). In practice, it is not necessary to use a separate tube (230A) but instead the sample and reagent can be contacted or mixed in any fashion. After allowing the mixture of reagent (200) and sample (210) to react (time indicated by arrow (235)), the single stranded oligo-conjugated antigens (201) will bind with the antibody (211) to form a single stranded oligo-antigen-antibody complex (231).

In the embodiment shown in this FIG. 4, the reaction mixture containing the single stranded oligo-antigen-antibody complex (231) is transferred (240) to a vessel (shown here as test tube (250)), which comprises immobilized antbody (251). Any oligo-antigen complex (201) that has not formed an oligo-antigen-antibody complex (231) will bind to the immobilized antigen (251), thereby resulting in removal of unreacted oligo-antigen conjugates (201) from solution through the formation of immobilized single stranded single stranded oligo-antigen-antibody complex (252).

The solution phase of the reaction performed in test tube (250) is then transferred (260) to the electrochemical nucleic acid detection chip (270). Electrochemical DNA detection chip (270) comprises one or more electrode surfaces (275 and 275A) on which a single stranded oligonucleotides (271) have been immobilized. Oligonucleotide (271) is complementary to the oligonucleotide present in the reagent (201). Hybridization of oligonulcleotide (271) with the single stranded oligo-antigen-antibody complex (231) results in double stranded nucleotide species (272) which is subsequently detected. Also shown is immobilized single stranded oligonucleotide (276) on a separate electrode surface (175A). Oligonucleotide 276 in most instances have a different sequence than the nucleic acid (271) mobilized on electrode 275. Both electrodes would be utilized if a multiplexed system were employed.

The binding reaction between the sample and the capture-associated universal oligos is performed in solution, in a physiological buffer such as phosphate buffered saline (PBS) supplemented with a non-specific blocking agent, such as fetal or new-born calf serum, and may be used when the target antigen to be detected is normally found under physiological conditions. However, the methods of the present invention are not limited to detecting target agents only found in physiological conditions. Those of skill in the art would appreciate and understand that different antibodies may be used in different conditions without affecting the ability to bind the particular target antigen to be detected. The binding reaction can be performed at a temperature within the range of 0° C. to 100° C., preferably at a temperature between 2° C. and 40° C., and more preferably within the range of about 4° C. to about 37° C., and most preferably within the range of about 18° C. to about 25° C. . The binding reaction is typically conducted from about 5 minutes to 12 hours, preferably from about 10 minutes to 6 hours, and more preferably from about 15 minutes to 1 hour. The duration of the binding reaction depends on several factors, including the temperature, suspected concentration of the target agent, ionic strength of the sample, and the like. For example, a binding reaction may require 15 minutes incubation at a temperature of 18° C., or 30 minutes incubation at a temperature of 4° C.

Since target agents and capture moieties (immobilized in the case of the immobilized binding partners) are involved in the capture reaction as in the binding reaction, typically the capture reaction between the reacted and unreacted capture-associated universal oligos and the immobilized binding partners is performed under conditions much like the binding reaction. The capture reaction also may take place in solution, in a physiological buffer such as phosphate buffered saline (PBS) supplemented with a non-specific blocking agent, such as fetal or new-born calf serum. The capture reaction can be performed at a temperature within the range of 0° C. to 100° C., preferably at a temperature between 2° C. and 40° C., and more preferably within the range of about 4° C. to about 37° C., and most preferably within the range of about 18° C. to about 25° C. . The capture reaction is typically conducted from about 5 minutes to 12 hours, preferably from about 10 minutes to 6 hours, and more preferably from about 15 minutes to 1 hour. Those of skill in the art would appreciate and understand the particular the specific time required for the reaction to be performed.

The removal of excess, unreacted capture-associated universal oligos can be achieved by providing immobilized binding partner(s) to the specific capture moiety that is conjugated to the capture-associated universal oligos. The immobilized binding partner is bound to a matrix that is a vessel wall or floor. Alternatively, the matrix may be a column or filter, such as Sepharose 2B, Sepharose 4B, Sepharose 6B, CNBR-activated Sepharose 4B, AH-Sepharose 4B, CH-Sepharose 4B, Activated CH-Sepharose 4B, epoxy-Activated Sepharose 6B, Activated Thiol-Sepharose 4B, Sephadex, CM-Sephadex, ECH-Sepharose 4B, EAH-Sepharose 4B, NHS-activated Sepharose or Thiopropyl Sepharose 6B, etc., all of which are supplied by Pharmacia; BIO-GEL A, Cellex, Cellex AE, Cellex-CM, Cellex PAB, BIO-GEL P, Hydrazide BIO-GEL P, Aminoethyl BIO-GEL P, BIO-GEL CM, AFFI-GEL 10, AFFI-GEL 15, AFFI-PREP10, AFFI-GEL HZ, AFFI-PREP HZ, AFFI-GEL 102, CM BIO-GEL A, AFFI-GEL herparin, AFFI-GEL 501 OR AFFI-GEL 601, etc., all of which are supplied by Bio-Rad; Chromagel A, Chromagel P, Enzafix P-HZ, Enzafix P-SH or Enzafix P-AB, etc., all of which are supplied by Wako Pure Chemical Industries Ltd.; AE-Cellurose, CM-Cellurose or PAB Cellurose etc., all of which are supplied by Serva, over which the mixture of reacted and unreacted conjugated nucleic acid molecules can be passed. Similarly, the matrix may include a suspension of particulate matter in a solution, such as microscopic and/or macroscopic beads/particles, where the immobilized binding partner is immobilized on the beads or particle such as polystyrene-, cellulose-, latex-, silica-, polyaminostyrene-, agarose-, polydimethylsiloxane-, or polyvinyl-based beads. In a method using particles, the unreacted nucleic acid molecules will be retained on the semi-solid support created by the particles, whereas the reacted nucleic acid molecules will be eluted through the semi-solid support. Thus, only those capture-associated universal oligos that have bound the particular target agent will be available for hybridization. Alternatively, the particles can include an immobilized binding partner specific for the target antigen or for the antibody/antigen complex. In this embodiment, only those capture-associated universal oligos conjugated to an antibody that has reacted with the target antigen in the sample will be retained on the particles or matrix, and the unreacted nucleic acid molecules will pass through. The retained, reacted capture-associated universal oligos then may be selectively released/eluted by known methods including but not limited to the cleavage step, discussed in detail below. Beads and particles can be separated from solution by using centrifugation, filtration, size exclusion chromatography, magnetism or other techniques known in the art.

When employing suspensions of particulate matter in a solution, unreacted nucleic acid molecules can be separated from the reacted nucleic acid molecules by techniques such as centrifugation, size exclusion chromatography, filtration and the like. In a method using beads, in particular magnetic beads, the separation step can be achieved by applying a magnetic field to the magnetic beads. In some embodiments, the beads will bind with the unreacted capture moieties, leaving the reacted capture moieties in solution and available for hybridization. In other embodiments, the beads will bind with the reacted capture moieties, leaving the unreacted capture moieties in solution. In addition, either the suspension or bead techniques can employ a particle or bead having a secondary capture moiety specific for the target agent to be detected. In this instance only those capture-associated universal oligos are that have reacted with the target agent in the sample will be retained on the beads, and the unreacted capture-associated universal oligos are separated from the suspension by known techniques including, but not limited to, centrifugation, size exclusion chromatography, filtration, magnetism and the like. As discussed above, in this particular embodiment of the invention, the retained, reacted capture-associated universal oligos can be selectively released/eluted by known methods including, but not limited to, the cleavage step, as discussed.

The capture-associated universal oligos preferably are provided in excess, with the excess (i.e., unreacted) capture-associated universal oligos being removed prior to hybridization. This excess is typically determined relative to the suspected level of target agent present in the sample. This relative excess can be from about 1:1 to 1000000:1, preferably 2:1 to about 10000:1, and more preferably from about 4:1 to 1000:1, and most preferably from 5:1 to 100:1. For example, when the capture moiety is an antibody, typically, an excess of capture moiety can be created by adding 1 μg of the capture-associated universal oligo to a sample suspected of containing up to 1 million target agents to be detected. This ratio gives rise to a molar ratio of typically about 4:1, but can vary dependant upon the molecular mass of the antibody and the target agent to be detected.

In some embodiments of the invention, cleavage of the antibody from the capture-associated universal oligos following separation of reacted and unreacted molecules, but prior to hybridization, is preferable. This situation may arise when the reacted capture-associated universal oligos have been selectively bound to a capture moiety that may interfere with hybridization, or detection, because of the physical size or the presence of local areas of electron density on the surface of the capture moiety. Cleavage can be achieved by, for example, a digestive enzyme, i.e., an enzyme that causes hydrolysis of a bond in a molecule, (e.g., proteolytic enzymes, lipases, phosphatases, phosphodiesterases, esterases, etc.), endonucleases, exonucleases, a restriction endonuclease (e.g., EcoRI), or a flap endonuclease (e.g., FEN-1, RAD2, XPG, etc.). The choice of cleavage method will depend on the nature of the conjugation of the capture moiety to the capture-associated universal oligo, and the moiety to be removed via the cleavage reaction. For example, photocleavage may be employed where a photocleavable phosphoramidite is used in lieu of a restriction site. Those of skill in the art will readily appreciate and understand the circumstances under which one particular method of cleavage would be preferred over another method of cleavage.

For example, a digestive enzyme, such as trypsin, can be used when an antibody is conjugated to the capture-associated universal oligo through some peptide linkage; a restriction endonuclease can be used when there is a specific sequence present in the capture-associated universal oligo, susceptible to the particular restriction endonuclease, between the portion of the capture-associated universal oligo that is complementary to the array-associated universal oligo molecule and the portion of the capture-associated universal oligo that is conjugated to the capture moiety. In preferred embodiments, restriction sites and restriction endonucleases are chosen that allow cleavage of single stranded nucleic acids. Likewise, a flap endonuclease, such as RAD2, or XPG, could be used when there is a specific structure present in the capture-associated universal oligo, susceptible to the particular flap endonuclease, between the portion of the capture-associated universal oligo that is complementary to the array-associated universal oligo molecule and the portion of the capture-associated universal oligo that is conjugated to the capture moiety. Those of skill in the art would appreciate and understand the particular types of structure susceptible to flap endonuclease cleavage.

Where it is intended that a restriction endonuclease will be used to separate the antibody from the capture-associated universal oligo, the capture-associated universal oligo will be engineered to contain a specific restriction site between the portion of the capture-associated universal oligo that is complementary to the array-associated universal oligo molecule and the portion of the capture-associated universal oligo that is conjugated to the antibody. This restriction site will be designed, and the appropriate restriction endonuclease selected, to cleave only in the the portion of the capture-associated universal oligo that is conjugated to the antibody and not in the region of complementarity to the array-associated nucleic acid molecule.

In those embodiments where such cleavage is performed, the cleavage reaction is performed after the capture reaction has been completed and after a selective purification reaction is employed in order to segregate the desired reaction product (i.e., the composition comprising the antibody and target antigen); for example, the reaction product can be subjected to a secondary capture (e.g., using a secondary immobilized antibody) followed by separation and wash procedures. The immobilized capture-associated universal oligo complex may then be eluted or otherwise separated from its immobilized substrate and the resulting solution containing the released capture-associated universal oligo transferred to chip for hybridization and detection.

In certain situations, it may be beneficial to use isothermal amplification to increase the number of nucleic acids available for binding to the array-associated universal oligos, thus enhancing the signal created through complementary binding. In this embodiment, the capture-associated universal oligo is used as a template for linear amplification, and the capture-associated universal oligo also is designed to encode the complementary sequence to a polymerase recognition sequence at its 3′ end following the region of complementarity to the array-associated universal oligo. Following binding of the target antigen to the antibody and isolation from the sample, an oligonucleotide encoding the 5′ to 3′ polymerase recognition sequence is introduced to the capture-associated universal oligo-target agent complex, and its binding to the complex creates a double-stranded polymerase recognition site. Following annealing of the oligonucleotide, the capture-associated universal oligo is exposed to an aqueous solution comprising the polymerase and an excess of NTP or dNTP under conditions that allow the polymerase and reactants to create an intermediate duplex comprising a double stranded DNA having a first 5′ end which bears a phage-encoded RNA polymerase recognition site. This reaction continues as the polymerase displaces the doubles stranded nucleic acid, resulting in multiple copies of the capture-associated universal oligo. In such an embodiment, the array-associated universal oligo will have the same sequence as the capture-associated universal oligo, and both will be complementary to the linear amplification products.

In a preferred embodiment, the polymerase recognition site created by this double stranded region is a phage-encoded RNA polymerase recognition sequence. Exemplary polymerases useful in such isothermal amplification reactions include RNA phage polymerases, including but not limited to T3 polymerase, SP6 polymerase, and T7 polymerase. In a more preferred embodiment, a mutant phage-encoded polymerase (e.g., the T7 RNA polymerase mutant Y639F or S641A) is used to allow creation of DNA rather than RNA. This will increase the stability of the synthesized nucleic acids for binding to the electrode, and obviate the problem of RNAse activity. Such mutant polymerases include T7 DNA polymerase, as disclosed in U.S. Pat No. 6,531,300, U.S. Pat. No. 6,107,037, U.S. Pat. No. 5,849,546, and Padilla and Sousa, Nucleic Acids Res 1999 27(6):1561-1563.

A number of different nucleotides can be used in the isothermal linear amplification reaction. These include not only the naturally occurring nucleoside mono-, di-, and triphosphates: deoxyadenosine mono-, di- and triphosphate; deoxyguanosine mono-, di- and triphosphate; deoxythymidine mono-, di- and triphosphate; and deoxycytidine mono-, di- and triphosphate (referred to herein as dA, dG, dT and dC or A, G, T and C, respectively). Nucleotides also include, but are not limited to, modified nucleotides and nucleotide analogs such as deazapurine nucleotides, e.g., 7-deaza-deoxyguanosine (7-deaza-dG) and 7-deaza-deoxyadenosine (7-deaza-dA) mono-, di- and triphosphates, deutero-deoxythymidine (deutero-dT) mon-, di- and triphosphates, methylated nucleotides e.g., 5-methyideoxycytidine triphosphate, 13C/15N labelled nucleotides and deoxyinosine mono-, di- and triphosphate. When using dNTPs and a traditional RNA polymerase, dUTP is substituted for dTTP. For those skilled in the art, it will be clear upon reading the present disclosure that modified nucleotides and nucleotide analogs that utilize a variety of combinations of functionality and attachment positions can be used in the present invention.

Asymmetric amplification using a heat stable polymerase such as Thermus aquaticus polymerase can also be used to create multiple copies of a nucleic acid complementary to the array-associated universal oligo. Suitable methods of asymmetric amplification are described in U.S. Pat. No. 5,066,584, which is incorporated by reference in its entirety. In such an embodiment, the array-associated universal oligo will have the same sequence as the capture-associated universal oligo, and both will be complementary to the asymmetric amplification products.

Amplification using the Phi29 polymerase may also be used to create multiple copies of the nucleic acids complementary to the array-associated universal oligo. Such methods are described in U.S. Pat. No. 5,712,124 and U.S. Pat. No. 5,455,166, both of which are incorporated by reference in their entirety. In brief, the Phi29 polymerase method will allow amplification of the capture-associated universal oligo to produce complementary nucleic acids at a single temperature by utilizing the Phi29 polymerase in conjunction with an endonuclease that will nick the polymerized strand, allowing the polymerase to displace the strand without digestion while generating a newly polymerized strand. As with asymmetric amplification, an oligonucleotide complementary to the 3′ end of the capture-moiety capture-associated universal oligo is used under conditions to create a series of single-stranded molecules complementary to the associated nucleic acid. In such an embodiment, the array-associated universal oligo will have the same sequence as the capture-associated universal oligo, and both will be complementary to the asymmetric amplification products.

In a particular embodiment of the invention, the oligo portion of the capture-associated universal oligo is cleaved from the capture-associated universal oligo complex prior to linear or asymmetric amplification. Following binding of the target antigen to the antibody and isolation from the sample, an oligonucleotide encoding the 5′ to 3′ polymerase recognition sequence and a restriction endonuclease sequence is introduced to the antibody-target antigen complex, and the binding of this oligonucleotide to the capture-associated universal oligo creates both a double-stranded polymerase recognition site and a restriction endonuclease cleavage site. Following annealing, the capture-associated universal oligo complex is exposed to the appropriate restriction endonuclease under conditions to allow the cleavage of the capture moiety-target agent from the associated nucleic acid. The restriction endonuclease is then optionally inactivated (e.g., through heat inactivation by exposing the solution to a temperature of 65° C. for 10 minutes), and the capture-associated universal oligo oligo may then be isolated from the severed antibody-antigen complex. Following cleavage and optional inactivation or isolation, the capture-associated universal oligo is combined with an aqueous solution comprising the polymerase and an excess of NTP or dNTP under conditions such that the polymerase and reactants create an intermediate duplex comprising a double stranded DNA having a first 5′ end which bears a phage-encoded RNA polymerase recognition site. This reaction continues as the polymerase displaces the double stranded nucleic acid, resulting in multiple copies of complementary nucleic acid. In such an embodiment, the array-associated universal oligo will have the same sequence as the capture-associated universal oligo, and both will be complementary to the linear amplification products.

The hybridization reaction between the capture-associated universal oligos and the array-associated universal oligos is typically performed in solution where the metal ion concentration of the buffer is between 0.01 mM to 5 M and a pH range of pH 5 to pH 10. Other components can be added to the buffer to promote hybridization such as dextran sulfate, EDTA, surfactants, etc. The hybridization reaction can be performed at a temperature within the range of 10° C. to 90° C., preferably at a temperature within the range of 25° C. to 60° C., and most preferably at a temperature within the range of 30° C. to 50° C. Alternatively, the temperature is chosen relative to the Tm's of the nucleic acid molecules employed. The reaction is typically performed at an incubation time from 10 seconds to about 12 hours, and preferably an incubation time from 30 seconds to 5 minutes. A variety of hybridization conditions may be used in the present invention, including high, moderate and low stringency conditions; see for example Maniatis et al., Molecular Cloning: A Laboratory Manual, 3rd Edition (2001), hereby incorporated by reference. Persons of ordinary skill in the art will recognize that stringent conditions are sequence-dependent and are dependent upon the totality of the conditions employed. Longer sequences typically hybridize specifically at higher temperatures. Generally, stringent conditions are selected to be about 5-10° C. lower than the thermal melting point (Tm) for the specific sequence at a defined ionic strength pH. Stringent conditions will be those in which the salt concentration is less than about 1.0 M sodium ion, typically about 0.01 to 1.0 M sodium ion concentration (or other salts) at pH 7.0 to 8.3 and the temperature is at least about 30° C. for short probes (e.g. 10 to 50 nucleotides) and at least about 60° C. for long probes (e.g. greater than 50 nucleotides). Stringent conditions may also be achieved with the addition of destabilizing agents such as formamide. The hybridization conditions may also-vary when a non-ionic backbone, i.e., PNA is used, the advantages of using PNA is discussed above. The hybridization reaction can also be controlled electrochemically by applying a potential to the electrodes to speed up the hybridization. Alternatively, the potential can be adjusted to ensure specific hybridization by increasing the stringency of the conditions.

In one embodiment, detection of a hybridization event can be enhanced by the use of an electrochemical hybridization detector. This electrochemical hybridization detector can be, for example, an intercalating agent characterized by a tendency to intercalate specifically to double stranded nucleic acid such as double stranded DNA. These intercalating agents have in their molecules a flat intercalating group such as a phenyl group, which intercalates between the base pairs of the double stranded nucleic acid, therefore binding to the double stranded nucleic acid. Most intercalating agents comprise conjugated electron structures and are therefore optically active; some are commonly used in the quantification or visualization of nucleic acids. Certain intercalating agents exhibit an electrode response, thereby generating or enhancing an electrochemical response. As such, determination of physical change, especially electrochemical change, may serve to detect the intercalating agents bound to a double stranded nucleic acid and so enhance the detection of a hybridization reaction.

Additionally, intercalators may be used for electrochemical detection where the intercalator molecule itself may or may not be able to enhance electrochemical detection, but where the intercalator is conjugated to molecules that enhance electrochemical detection (electrochemical enhancing conjugates) in a formula such as I—(X)ₘ—(Y)ₙ, where I is an intercalator, X is a linking moiety, and Y is an electrochemical enhancing entity (such as an electron acceptor). For example, the minor groove binder Hoechst 33258, itself an electrochemical detection enhancer, may be conjugated to additional molecules of Hoechst 33258, another intercalator, an complexed transition metal electrochemical detection enhancer, metallocene, as described herein or any other electrochemical detection enhancer. The electrochemical enhancing conjugates can be attached to the intercalator by covalent or non-covalent linkages. If the electrochemical enhancing conjugates are attached covalently, the functional groups include haloformyl, hydroxy, oxo, alkyl, alkenyl, alkynyl, amide, amino, ammonio, azo, benzyl, carboxy, cyanato, thiocyanato, alkoxy, halo, imino, isocyano, isothiocyano, keto, cyano, nitro, nitroso, peroxy, phenyl, phosphino, phosphono, phospho, pyridyl, sulfonyl, sulto, sulfinyl, or mercaptosylfanyl, with preferred functional groups being amino, carboxy, oxo, and thiol groups, and with amino groups being particularly preferred. In addition, homo- or hetero-bifunctional linkers may be used and are well known in the art. As will be appreciated by those in the art, a wide variety of intercalators, electrochemical enhancing conjugates and functional groups may be used.

Electrochemically active intercalating agents useful in the present invention are, but are not limited to, ethidium, ethidium bromide, acridine, aminoacridine, acridine orange, proflavin, ellipticine, actinomycin D, daunomycin, mitomycin C, HOECHST 33342, HOECHST 33258, aclarubicin, DAPI, Adriamycin, pirarubicin, actinomycin, tris(phenanthroline)zinc salt, tris(phenanthroline)ruthenium salt, tris(phenantroline)cobalt salt, di(phenanthroline)zinc salt, di(phenanthroline)ruthenium salt, di(phenanthroline)cobalt salt, bipyridine platinum salt, terpyridine platinum salt, phenanthroline platinum salt, tris(bipyridyl)zinc salt, tris(bipyridyl)ruthenium salt, tris(bipyridyl)cobalt salt, di(bipyridyl)zinc salt, di(bipyridyl)ruthenium salt, di(bipyridyl)cobalt salt, and the like. Other intercalating agents, which are useful, are those listed in Published Japanese Patent Application No. 62-282599. Some of these intercalators contain metal ions and can be considered transition metal complexes. Although the transition metal complexes are not limited to those listed above, complexes which comprise transition metals having oxidation-reduction potentials not lower than or covered by that of nucleic acids are less preferable. The concentration of the intercalator depends on the type of intercalator to be used, but it is typically within the range of 1 ng/ml to 1 mg/ml. Some of these intercalators, specifically Hoechst 33258, has been shown to be a minor-groove binder and specifically binds to double-stranded DNA. The use of such electrochemically active minor groove binders is useful for detection of hybridization in electrochemical detection methods. Thus, in accordance with the present invention, the term “intercalator” is not intended to be limited to those compounds that “intercalate” into the rungs of the DNA ladder structure, but is also intended to include any moiety capable of binding to or with nucleic acids including major and minor groove binding moieties.

Transition metals are those whose atoms have a partial or complete d orbital shell of electrons. Suitable transition metals for use in conjunction with the present invention include, but are not limited to, cadmium (Cd), copper (Cu), cobalt (Co), palladium (Pd), zinc (Zn), iron (Fe), ruthenium (Ru), rhodium (Rh), osmium (Os), rhenium (Re), platinum (Pt), scandium (Sc), titanium (Ti), Vanadium (V), chromium (Cr), manganese (Mn), nickel (Ni), Molybdenum (Mo), technetium (Tc), tungsten (W), and iridium (Ir). That is, the first series of transition metals, the platinum metals (Ru, Rh, Pd, Os, Ir and Pt), along with Fe, Re, W, Mo and Tc, are preferred. Particularly preferred are ruthenium, rhenium, osmium, platinum, cobalt and iron.

The transition metals are commonly complexed with a variety of ligands, to form suitable transition metal complexes. As will be appreciated by those in the art, the number and nature of the co-ligands will depend on the coordination number of the metal ion. Mono-, di- or polydentate co-ligands may be used at any position. Suitable ligands fall into two categories: ligands, which use nitrogen, oxygen, sulfur, carbon or phosphorus atoms (depending on the metal ion) as the coordination atoms (generally referred to in the literature as sigma (Σ) donors) and organometallic ligands such as metallocene ligands (generally referred to in the literature as pi (n) donors). Suitable nitrogen donating ligands are well known in the art and include, but are not limited to, NH₂ ; NHR; NRR′; pyridine; pyrazine; isonicotinamide; imidazole; bipyridine and substituted derivatives of bipyridine; terpyridine and substituted derivatives; phenanthrolines, particularly 1,10-phenanthroline (abbreviated phen) and substituted derivatives of phenanthrolines such as 4,7-dimethylphenanthroline and dipyridol[3,2-a:2′,3′-c]phenazine (abbreviated dppz); dipyridophenazine; 1,4,5,8,9,12-hexaazatriphenylene (abbreviated hat); 9,10-phenanthrenequinone diimine (abbreviated phi); 1,4,5,8-tetraazaphenanthrene (abbreviated tap); 1,4,8,11-tetra-azacyclotetradecane (abbreviated cyclam), EDTA, EGTA and isocyanide. Substituted derivatives, including fused derivatives, may also be used. In some embodiments, porphyrins and substituted derivatives of the porphyrin family may be used. See for example, Comprehensive Coordination Chemistry, Ed. Wilkinson et al., Pergammon Press, 1987, Chapters 13.2 (pp73-98), 21.1 (pp. 813-898) and 21.3 (pp 915-957), all of which are hereby expressly incorporated by reference.

Suitable sigma donating ligands using carbon, oxygen, sulfur and phosphorus are known in the art. For example, suitable sigma carbon donors are found in Cotton and Wilkinson, Advanced Organic Chemistry, 5th Ed., John Wiley & Sons (1988), hereby incorporated by reference; see, e.g., page 38. Similarly, suitable oxygen ligands include crown ethers, water and others known in the art. Phosphines and substituted phosphines are also suitable; see, e.g., page 38 of Cotton and Wilkinson. The oxygen, sulfur, phosphorus and nitrogen-donating ligands are attached in such a manner as to allow the heteroatoms to serve as coordination atoms.

Such organometallic ligands include cyclic aromatic compounds such as the cyclopentadienide ion [C₅Hs(−1)] and various ring substituted and ring fused derivatives, such as the indenylide (−1) ion, that yield a class of bis(cyclopentadieyl) metal compounds, (i.e. the metallocenes); see, e.g., Robins et al., J. Am. Chem. Soc. 104:1882-1893 (1982); and Gassman et al., J. Am. Chem. Soc. 108:4228-4229 (1986), incorporated by reference. Of these, ferrocene [(C₅H₅)₂Fe] and its derivatives are prototypical examples, which have been used in a wide variety of chemical (Connelly et al., Chem. Rev. 96:877-910 (1996), incorporated by reference) and electrochemical (Geiger et al., Advances in Organometallic Chemistry 23:1-93; and Geiger et al., Advances in Organometallic Chemistry 24:87, incorporated by reference) electron transfer or “redox” reactions. Metallocene derivatives of a variety of the first, second and third row transition metals are potential candidates as redox moieties that are covalently attached to the nucleic acid. Other potentially suitable organometallic ligands include cyclic arenes such as benzene, to yield bis(arene)metal compounds and their ring substituted and ring fused derivatives, of which bis(benzene)chromium is a prototypical example. Other acyclic pi-bonded ligands such as the allyl(−1)ion, or butadiene yield potentially suitable organometallic compounds, and all such ligands, in conjunction with other pi-bonded and delta-bonded ligands constitute the general class of organometallic compounds in which there is a metal to carbon bond. Electrochemical studies of various dimers and oligomers of such compounds with bridging organic ligands, and additional non-bridging ligands, as well as with and without metal-metal bonds are potential candidate redox moieties in nucleic acid analysis.

When one or more of the co-ligands is an organometallic ligand, the ligand is generally attached via one of the carbon atoms of the organometallic ligand, although attachment may be via other atoms for heterocyclic ligands. Preferred organometallic ligands include metallocene ligands, including substituted derivatives and the metalloceneophanes (see page 1174 of Cotton and Wilkenson, supra). For example, derivatives of metallocene ligands such as methylcyclopentadienyl, with multiple methyl groups being preferred, such as pentamethylcyclopentadienyl, can be used to increase the stability of the metallocene. In a preferred embodiment, only one of the two metallocene ligands of a metallocene is derivatized.

Alternatively, in some embodiments, the capture-associated universal oligo may be labeled with an electroactive marker. Such electroactive markers can include, but are not limited to, ferrocene derivatives, anthraquinone, silver and silver derivatives, gold and gold derivatives, osmium and osmium derivatives, ruthinium and ruthinium derivatives, cobalt and cobalt derivatives and the like.

When traditional microarray technology is employed using fluorescence to detect a hybridization event between the capture-associated universal oligo and the three dimensional array-associated universal oligo, an optical detection device is used for detection (see, e.g., U.S. Pat. Nos. 5,578,832; 5,631,734; 5,834,758; 6,025,601; 6,141,096 and 6,252,236, the complete disclosures of which are incorporated herein by reference). Such devices generally employ a scanning device which rapidly sweeps an activation radiation beam or spot across the surface of the chip substrate. Optical detection devices also include focusing optics for focusing the excitation radiation onto the surface of the substrate in a sufficiently small area to provide high resolution of features on the substrate, while simultaneously providing a wide scanning field. An image is obtained by detecting the electromagnetic radiation emitted by the labels on the sample when the labels are illuminated. In some embodiments, fluorescent emissions are gathered by the focusing optics and detected to generate an image of the fluorescence on the substrate surface. The optical detection devices may further employ confocal detection systems to reduce or eliminate unwanted signals from structures above and below the plane of focus of the excitation radiation, as well as autofocus systems to focus both the activation radiation on the substrate surface and the emitted radiation from the surface. Generally, the excitation radiation and response emission have different wavelengths.

In operation, optical detection devices include one or more sources of excitation radiation. Typically, these source(s) are immobilized or stationary point light sources, e.g., lasers such as argon, helium-neon, diode, dye, titanium sapphire, frequency-doubled diode pumped Nd:YAG and krypton. Typically, the excitation source illuminates the sample with an excitation wavelength that is within the visible spectrum, but other wavelengths (i.e., near ultraviolet or near infrared spectrum) may be used depending on the application. In some cases, the label is excited with electromagnetic radiation having a wavelength at or near the absorption maximum of the species of label used. Exciting the label at such a wavelength produces the maximum number of photons emitted. For example, if fluorescein (absorption maximum of 488 nm) is used as a label, an excitation radiation having a wavelength of about 488 nm would induce the strongest emission from the labels.

The excitation radiation from the point source is directed at a movable radiation direction system which rapidly scans the excitation radiation beam back and forth across the surface of the substrate. A variety of devices may be employed to generate the sweeping motion of the excitation radiation. For example, resonant scanner or rotating polygons, may be employed to direct the excitation radiation in this sweeping fashion. Generally, however, galvanometer devices are preferred as the scanning system. In addition, an optical train may be employed between the activation source and the galvanometer mirror to assist in directing, focusing or filtering the radiation directed at and reflected from the galvanometer mirror.

The galvanometers employed in such optical detection devices and systems of the present invention typically sweep a scanning spot across the substrate surface at an oscillating frequency that is typically greater than 30 Hz. The objective lens is preferably selected to provide high resolution, as determined by the focused spot size, while still allowing a wide scanning field.

As the activation radiation spot is swept across the surface of the substrate, it activates fluorescent groups on any capture-associated universal oligos that have bound to the array-associated universal oligos. The activated groups emit a response radiation or emission which is then collected by the objective lens and directed back through the optical train via the servo mounted mirror. In order to avoid the detrimental effects of reflected excitation radiation upon the detection of the fluorescence, dichroic mirrors or beam splitters may be included in the optical train. These dichroic beam splitters or mirrors are reflective to radiation in the wavelength of the excitation radiation while transmissive to radiation in the wavelength of the response radiation. For example, where an Argon laser is used as the point energy source, it will typically generate activation radiation having a wavelength of about 488 nm. Fluorescence emitted from an activated fluorescein moiety on the other hand will typically have a wavelength between about 515 and 545 nm. As such, dichroic mirrors may be included which transmit light having a wavelength greater than 515 nm while reflecting light of shorter wavelengths. This effectively separates the excitation radiation reflected from the surface of the substrate from the response radiation emitted from the surface of the substrate. Additional dichroic mirrors may be used to separate signals from label groups having different response radiation wavelengths, thereby allowing simultaneous detection of multiple fluorescent indicators.

Following separation of the response radiation from the reflected excitation radiation, the response radiation or fluorescence is then directed at a detector, e.g., a photomultiplier tube, to measure the level of response radiation and record that level as a function of the position on the substrate from which that radiation originated. Typically, the response radiation is focused upon the detector through a spatial filter such as a confocal pinhole. Spatial filters reduce or eliminate unwanted signals from structures above and below the plane of focus of the excitation radiation. Additionally, the device may incorporate a bandpass filter between the dichroic mirror and the detector to further restrict the wavelength of radiation that is delivered to the detector.

The present invention also contemplates the use of kits to detect target agents. The kits can include capture-associated universal oligos and immobilized binding partners to the capture moieties. The kit also includes a universal oligo three dimensional array comprising a plurality of array-associated universal oligos. In addition, the kit can include a label for fluorescent detection or an electrochemical hybridization indicator for electrochemical detection.

### EXAMPLE I

### Preparation of Monoclonal Antibodies

A peptide corresponding to amino acid residues in a desired target agent, in this case an antigen, is synthesized with a peptide synthesizer (Applied Biosystems) according to methods known in the art. The peptide emulsified with Freund's complete adjuvant is used as an immunogen. And administered to mice by footpad injection for primary immunization (day 0). The booster immunization is performed four times or more in total. The final immunization is carried out by the same procedure two days before the collection of lymph node cells. The lymph node cells collected from each immunized mouse and mouse myeloma cells are mixed at a ratio of 5:1. Hybridomas are prepared by cell fusion using polyethylene glycol 4000 or polyethylene glycol 1500 (GIBCO) as a fusing agent. The lymph node cells of the mouse are fused with mouse myeloma PAI cells (JCR No. B0113; Res. Disclosure Vol. 217, p. 155, 1982), and the resulting hybridomas are selected by culturing the fused cells in an ASF104 medium (Ajinomoto Co. Inc.) containing HAT supplemented with 10% fetal calf serum (FCS) and aminopterin. The reactivity of the culture supernatant of each hybridoma clone to the is measured by ELISA.

Screening by ELISA is performed by adding the immunogen into each well of a 96-well ELISA microplate (Corning Costar Co.). The plate is incubated at room temperature for 2 hours for the adsorption of the immunogen onto the microplate. The supernatants are discarded and then the blocking reagent (200 μl; phosphate buffer containing 3% BSA) is added into each well. The plate is incubated at room temperature for 2 hours to block free sites on the microplate. Each well is washed three times with 200 μl of phosphate buffer containing 0.1% Tween 20. Supernatant (100 μl) from each hybridoma culture is added into each well of the plate, and the reaction is allowed to proceed for 40 minutes. Each well is then washed three times with 200 μl of phosphate buffer containing 0.1% Tween 20. In the next step, biotin-labeled sheep anti-mouse immunoglobulin antibody (50 μl; Amersham) is added to the wells and the plates are incubated at room temperature for 1 hour.

The microplate is washed with phosphate buffer containing 0.1% Tween 20. A solution of streptavidin-β-galactosidase (50 μl; Gibco-BRL), diluted 1000 times with a solution (pH 7.0) containing 20 mM HEPES, 0.5M NaCl and bovine serum albumin (BSA, 1 mg/ml), is added into each well. The plate is then incubated at room temperature for 30 minutes. The microplate is then washed with phosphate buffer containing 0.1% Tween 20. A solution of 1% 4-Methyl-umbelliferyl-β-D-galactoside (50 μl; Sigma) in a phosphate buffer (pH 7.0) containing 100 mM NaCl, 1 mM MgCl₂ and 1 mg/ml BSA, is added into each well. The plate is incubated at room temperature for 10 minutes. 1M Na₂CO₃ (100 μl) is added into each well to stop the reaction. Fluorescence intensity is measured in a Fluoroscan II Microplate Fluorometer (Flow Laboratories Inc.) at a wavelength of 460 nm (excitation wavelength: 355 nm).

### EXAMPLE II

### Preparation of DNA-Antibody Conjugates.

A capture-associated universal oligonucleotide can be prepared on a solid support that has been treated with 3-amino-1,2-propanediol in order to introduce the 3′ amino group with an automated DNA synthesizer (e.g., 3400 DNA synthesizer, Applied Biosystems). Typical cleavage and purification steps are employed to obtain the modified universal oligonucleotide. The universal oligonucleotide is then incubated with N-succinimidyl 3-(2-pyridyldithio)propionate in PBS at a molar ratio between 1:30 to 1:35 for 30 minutes at room temperature. Dithiothreitol is typically added to this solution, resulting in a final concentration of 10 mM for 5 minutes. The universal oligonucleotide is then purified and recovered by applying this reaction mixture to a PBS equilibrated Sepharose column, washing the column several times, and eluting the universal oligonucleotide in a 0.6M NaCl phosphate buffer.

A monoclonal antibody is incubated with γ-maleimidobutyric acid-N-hydroxysuccinimide ester in PBS at a molar ratio of between 1:15 and 1:20 for 30 minutes at room temperature. The maleimide derivatized antibody can then be purified by column chromatography.

The conjugation of the monoclonal antibody and the oligonucleotide is typically achieved by mixing the maleimide derivatized antibody and the sulphydryl containing oligonucleotide in a molar ratio between 1:10 and 1:16 and incubated overnight at 4° C. The resulting conjugates are purified by precipitation with a 50% saturated solution of (NH₄)₂SO₄ and extensive washing in the same (NH₄)₂SO₄ solution. Residual (NH₄)₂SO₄ can then be removed by dissolving the precipitate in PBS and gel filtration.

### EXAMPLE III

### Immobilization of Nucleic Acid Probe to a Platinum Electrode Surface

A platinum electrode is exposed to a high temperature to air-oxidize the surface of the electrode. The oxidized electrode is treated with cyanogen bromide (CNBr) to activate the oxide layer. The nucleic acid is attached to the electrode by contacting the electrode in a solution of single stranded nucleic acid. The single stranded nucleic acid is obtained by commonly employed means including, but not limited to, either standard oligonucleotide synthesis techniques or by thermal denaturation of a double stranded nucleic acid molecule.

Alternatively, a custom synthesized oligonucleotide containing a thiol group at the 5′ or the 3′ end is spotted on a gold electrode. This procedure involves placing approximately 100 nL of the probe solution containing the oligonucleotide probe (5 μmol/L), 400 mmol/L sodium chloride, and 0.1 mmol/L HCl, on the electrode and then keeping the electrode at room temperature for 1 h thereby resulting in the probes be immobilized onto the gold surface via a thiol moiety. Unattached probes are removed by washing the electrode with distilled water.

### EXAMPLE IV

### Binding of Target Agent (E. coli 0157:H7) and Removal of Excess Conjugate

A sample is obtained from a patient suffering from an E. coli 0157:H7 infection and can be diluted in PBS/Tween20. An oligonucleotide conjugated to an anti-E. coli 0157:H7 antibody (the procedure for conjugation is described in Example I) is contacted with the diluted sample by adding a one-third volume of bovine serum albumin (12% [wt/vol] in PBS) and 2 μg of antibody-nucleic acid conjugate. The resulting reaction is incubated at room temperature for 30 minutes.

Unbound antibody-nucleic acid conjugate is removed by magnetic microparticle depletion. Briefly, magnetic microparticles are coated with the epitope recognized by the anti-E. coli 0157:H7 antibody. The epitope-coated magnetic beads are added to the reaction mixture, in a PBS buffer supplemented with 0.5% BSA and 2 mM EDTA, and incubated at 4° C. for 30 minutes. Only those antibody-nucleic acid conjugates that have not bound to E. coli 0157:H7 in the sample are available to bind to the immobilized epitope. The magnetically labeled excess conjugate is separated from the reaction mixture by adding the mixture to a column packed with lattice-type matrix and applying a magnetic field. Such separation devices are known in the art (e.g., MACS® Columns, Miltenyi Biotec). The magnetically labeled antibody-nucleic acid conjugate is retained on the column; the target bound conjugates passing through the column and is available for detection.

### EXAMPLE V

### Cleavage of the Antibody from the Nucleic Acid Strand

Following the isolation of the target bound conjugates, it may be desirable in some instances to remove the antibody and the target agent from the nucleic acid prior to hybridization. This is accomplished by performing a cleavage reaction to cleave the nucleic acid between the portion of the nucleic acid that will hybridize to the electrode immobilized nucleic acid molecule and the conjugated antibody.

An oligonucleotide is synthesized as described in Example I with a “G-G-C-C” sequence between the conjugated antibody and the portion of the oligonucleotide that will hybridize to the electrode immobilized nucleic acid molecule. The restriction endonuclease, HaeIII (New England Biolabs), has been shown to cleave single stranded DNA at this specific sequence (Horiuchi & Zinder, 1975). The cleavage reaction is performed by mixing the HaeIII enzyme with the antibody-nucleic acid conjugate in a buffer containing 10 mM Tris-HCl, 50 mM NaCl, 10 mM MgC₂, 1 mM dithiothreitol, pH 7.9, and incubating at 37° C. for 30 minutes. The HaeIII enzyme is heat inactivated at 80° C. for 20 minutes. The cleaved nucleic acid molecules are separated from the antibody-antigen complex by standard techniques such as ethanol precipitation. Briefly, add 2.5-3 volumes of 95% ethanol/0.12 M sodium acetate to the DNA sample contained in a 1.5 ml microcentrifuge tube, invert to mix, and incubate in an ice-water bath for 10 minutes. The resulting mixture is centrifuged at 12,000 rpm in a microcentrifuge for 15 min at 4° C., decant the supernatant, and drain inverted on a paper towel. Ethanol (80%) (corresponding to about two volume of the original sample) is added and the reaction mixture is incubated at room temperature for 5-10 min followed by centrifugation for 5 min. The supernatant is then decanted. The sample is air dried (or alternatively lyophilized) and the pellet of DNA resuspended in 10 mM Tris-HCl, pH 7.6-8.0, 0.1 mM EDTA. For hybridization reactions, the nucleic acid is resuspended in SSC solution.

In an alternative cleavage method, photocleavage is performed. In doing so, an oligonucleotide is synthesized as described in Example I with a photocleavable nucleotide inserted into the sequence. This can be accomplished by using a photocleavable phosphoramidite during the synthesis of the oligonucleotide (Glen Research). The cleavage reaction is essentially performed by exposing the oligonucleotide-antibody conjugate to a source of ultraviolet (UV) light. The cleaved nucleic acid molecules are separated from the antibody-antigen complex by standard techniques such as ethanol precipitation, membrane filtration, or if the antibody-antigen complex is immobilized, but centrifugation, etc.

### EXAMPLE VI

### Hybridization of Nucleic Acid Molecules to the Electrode-Immobilized Nucleic Acid Molecules

The hybridization and detection reaction is carried out as follows. Single stranded nucleic acid in 2×SSC solution (300 mmol/L NaCl, 30 mmol/L trisodium citrate) are contacted with the probes immobilized on the electrode. The hybridization reaction is carried out at a temperature that permits specific hybridization of the two nucleic acid molecules. The temperature of the hybridization reaction is performed is determined using the equation for calculating the melting temperature of an oligonucleotide. It is possible to shorten the incubation time of this hybridization reaction by applying 0.1 V to the electrode. Using this procedure it may be possible to shorten the incubation time to 10 minutes.

To enhance detection, an electrochemical hybridization indicator, such as a minor groove binder is added. Briefly, a solution containing containing 50 μmol/L Hoechst 33258 (WAKO Pure Chemicals Industries, Ltd.) and 100 mmol/L NaCl is added before, during, or after hybridization. If the Hoechst 33258 is added after the hybridization reaction, then a further incubation of 5 minutes may be necessary. The electrochemical analysis is carried out with an electrochemical analyzer (Model BAS-100B) and software from Bioanalytical Systems, Inc. or the Genelyzer System from Toshiba Corporation. The cyclic voltammetry is typically carried out at 300 mV/s and 25° C., and the potential sweep range from −100 to 900 mV.

### EXAMPLE VII

### Binding of Target Agent (E. coli 0157:H7) and Alternative Method of Removal of Excess Conjugate

A sample is obtained from a patient suffering from an E. coli 0157:H7 infection and is diluted in PBS/Tween20. An oligonucleotide conjugated to an anti-E. coli 0157:H7 antibody (the procedure for conjugation is described in Example I) is contacted with the diluted sample by adding a one-third volume of bovine serum albumin (12% [wt/vol] in PBS) and 2 μg of antibody-nucleic acid conjugate. The resulting reaction is incubated at room temperature for 30 minutes.

Unbound antibody-nucleic acid conjugate is removed by magnetic microparticle depletion. Briefly, magnetic microparticles are coated with a second anti-E. coli 0157:H7 antibody, specific to another region (epitope) of the same target agent (binding partner, antigen) to be detected. The second antibody-coated magnetic beads are added to the reaction mixture, in a PBS buffer supplemented with 0.5% BSA and 2 mM EDTA, and incubated at 4° C. for 30 minutes. Only those antibody-nucleic acid conjugates that have bound to E. coli 0157:H7 in the sample are available to bind to the magnetic particle immobilized second anti-E. coli O157:H7 antibody, specific to another region (epitope) of the same target agent to be detected. The magnetically labeled conjugate is separated from the reaction mixture by adding the mixture to a column packed with lattice-type matrix and applying a magnetic field. Such separation devices are known in the art (e.g., MACS® Columns, Miltenyi Biotec). The magnetically labeled second antibody-nucleic acid conjugate that is bound to the target agent is retained on the column. The antibody-nucleic acid conjugate that is not bound to the target agent will pass through the column. Subsequently cleavage of the nucleic acid from the magnetically labeled second antibody-nucleic acid conjugate that is bound to the target agent is performed as described in example IV. This cleavage can be achieved by other approaches, described earlier in this invention. The cleavage products are then subjected to electrochemical detection.

### EXAMPLE VIII

### Binding of Target Agent (Human Anti-Hepatitis Antibodies) without Direct Interaction with the Causative Agent

A sample is obtained from a patient suspected of being infected with hepatitis. The sample is diluted in a diluent such as PBS/tween20. An oligonucleotide conjugated to a hepatitis-specific antigen is incubated with the diluted sample by adding a one third volume of bovine serum albumin (12% [wt/vol] in PBS) and 2 ug of the oligo nucleotide-antigen conjugate. Unbound nucleic acid-antigen complex is removed by magnetic microparticle-antibody affinity depletion. Briefly, magnetic micro-particles are coated with an antibody affinity reagent such as Protein A, Protein G or anti-class antibody which captures antibodies from the sample, a portion of which may be hepatitis antigen specific and bound to the antigen-oligo conjugate. The coated magnetic beads are added to the reaction mixture, in a PBS buffer supplemented with 0.5% BSA and 2 mm EDTA, and incubated at 40C for 30 minutes. Antibodies in the sample will be immobilized on the magnetic beads, only anti-hepatitis antibodies will contain the oligo-antigen conjugate. The magnetically labeled antibody affinity reagent, along with additional binding partners (oligo-antigen complexes) are separated from the rest of the sample and extensively washed with PBS/Tween20. Such separation techniques are known in the art (e.g., MACS Columns, Miltenyi Biotec). Subsequent release of the oligo from the antigen is performed as described in Example IV and other approaches, described herein.

While this invention is satisfied by embodiments in many different forms, as described in detail in connection with preferred embodiments of the invention, it is understood that the present disclosure is to be considered as exemplary of the principles of the invention and is not intended to limit the invention to the specific embodiments illustrated and described herein. Numerous variations may be made by persons skilled in the art without departure from the spirit of the invention. The scope of the invention will be measured by the appended claims and their equivalents. The abstract and the title are not to be construed as limiting the scope of the present invention, as their purpose is to enable the appropriate authorities, as well as the general public, to quickly determine the general nature of the invention. In the claims that follow, unless the term “means” is used, none of the features or elements recited therein should be construed as means-plus-function limitations pursuant to 35 U.S.C. §112, ¶6.

Each reference cited herein is incorporated by reference in its entirety.

1. A three dimensional array for detecting target agents comprising a support having two opposing surfaces, a plurality of pins projecting from at least one of said two opposing surfaces, wherein each pin comprises a surface with an array associated universal oligo disposed thereon.

2. The three dimensional array of claim 1, wherein a plurality of pins project from both opposing surfaces of said support, and wherein each pin comprises a surface having an electrodal compound disposed thereon, and further comprising a linking agent linked to said electrodal compound, wherein said array associated universal oligo is linked to said electrodal compound.

3. The three dimensional array of claim 2, wherein said electrodal compound is gold layered over titanium, wherein said linking agent is linked to the electrodal compound via a sulfur linkage, and wherein said linking agent is capable of forming a self-assembling monolayer.

4. A method of detecting a presence of one or more target agents in a sample comprising:
(a) mixing:
(i) capture-associated universal oligos conjugated to one or more capture moieties specific for said one or more target agents; and
(ii) a sample suspected of containing said target agents, thereby producing a mixture comprising reacted capture-associated universal oligo complexes and unreacted capture-associated universal oligo complexes;
(b) contacting the mixture of step (a) with immobilized binding partners to said one or more capture moieties in said sample so as to allow any of said unreacted capture-associated universal oligo complexes to bind with said immobilized binding partners resulting in an immobilized phase and a solution phase;
(c) separating the immobilized phase and solution phase;
(d) providing a detection device comprising the three-dimensional array of claim 4 having array-associated universal oligos, and wherein said detection device produces a signal if there is a hybridization event between said array-associated universal oligos and other nucleic acid molecules;
(e) introducing said solution phase from step (c) to the detection device from step (d); and
(h) detecting a signal generated by capture-associated universal oligos and array-associated universal oligos.

5. A method of detecting a presence of one or more target agents in a sample comprising:
(a) mixing:
(i) capture-associated universal oligos conjugated to one or more capture moieties specific for said one or more target agents; and
(ii) a sample suspected of containing said target agents, thereby producing a mixture comprising reacted capture-associated universal oligo complexes and unreacted capture-associated universal oligo complexes;
(b) contacting the mixture of step (a) with immobilized binding partners to said one or more target agents or to target agent/capture moiety complexes of said reacted capture-associated universal oligo complexes in said sample so as to allow any of said reacted capture-associated universal oligo complexes to bind with said immobilized binding partners resulting in an immobilized phase and a solution phase;
(c) separating the immobilized phase and solution phase;
(d) providing a detection device comprising the three dimensional array of claim 4 having array-associated universal oligos, and wherein said detection device produces a signal if there is a hybridization event between said array-associated universal oligos and other nucleic acid molecules;
(e) liberating said capture-associated universal oligo into a second solution phase from said immobilized phase;
(f) introducing said second solution phase from step (e) to the detection device from step (d); and
(g) detecting a signal generated by capture-associated universal oligos and array-associated universal oligos.
